(19) United States
(12) Patent Application Publication
(10) Pub. No.: US 2008/0189078 A1
(43) Pub. Date: Aug. 7, 2008

(54) Dispensing Systems

(76) Inventors: Peter George Vok, New South Wales (AU); George Vok, New South Wales (AU)

Correspondence Address: LADAS & PARRY LLP, 26 WEST 61ST STREET, NEW YORK, NY, 10023, US

(21) Appl. No.: 11/794,073

(22) PCT Filed: Dec. 21, 2005
(86) PCT No.: PCT/AU2005/001944

§ 371 Date: Nov. 15, 2007

Related U.S. Application Data
(60) Provisional application No. 60/686,213, filed on Jun. 1, 2005.

(30) Foreign Application Priority Data
Dec. 22, 2004 (AU) 2004907251
Jan. 31, 2005 (AU) 2005900380
May 27, 2005 (AU) 2005902742

(51) Int. Cl. G06F 15/00

(52) U.S. Cl. 702/188

(57) ABSTRACT

Apparatus (15) for dispensing drinks formed from a number of drink components (12). A valve (16A) includes a housing having a number of inlets for coupling to respective drink component sources (12) and a number of outlets, each outlet being coupled to a respective inlet via a respective flow path (17). A number of flow controllers (30, 31) are provided, each flow controller (30, 31) being provided in a respective flow path (17) for controlling the supply of the respective drink component (12). In another embodiment a connector for coupling a keg to a line, the connector being adapted to couple to a cleaning solution supply is disclosed. In a further embodiment a method presenting content and apparatus for presenting content involving a processing system is disclosed.

### BACKGROUND OF THE INVENTION

The present invention relates to systems for dispensing fluids, and in particular to beverage dispensing system.

### DESCRIPTION OF THE PRIOR ART

The reference to any prior art in this specification is not, and should not be taken as, an acknowledgment or any form of suggestion that the prior art forms part of the common general knowledge.

Presently in establishments where chilled drinks such as tap beer, or the like, are served this is typically achieved by having a pressurised barrel containing the drink to be dispensed. The barrel is then connected via a keg connector and beer line, to a tap, such that when the tap is opened, the pressure of the beer inside the barrel results in the beer being dispensed into a glass. In order to maintain the pressure of the drink inside the barrel, the keg connectors include a gas pressure line through which gas is forced into the keg, thereby pressurising the keg to urge liquid through the keg connector and subsequently into the dispensing line. In addition to this, a cooling system is usually used to cool the beer as it flows along the beer line, thereby ensuring that the drink is served at a desired chilled temperature.

Typically systems such as this require an operator, such as a barman to manually control the operation of the beer tap, to control the amount of drink being dispensed. This is a time consuming task, and can result in long waiting times in bar, or the like, during busy periods.

A second problem that occurs in systems like this is faults with either the barrel pressurisation system, or the chilling system. In particular, problems in these systems can result in the beer being under pressurised, or under chilled. This will generally result in a lower quality of the provided drink.

Whilst problems may be identified by trained bar persons, this is often not until after a number of drinks have been served. As these drinks will typically have to be replaced, this is wasteful, and can result in increased overheads for the owner of the establishment. Even worse however, is that the problem is not discovered or rectified, in which case the establishment will loose customers that are not satisfied with the drinks. This is also a problem for the drink supplier, such as the brewery, as they will need to ensure product standards are maintained.

In addition to this, in the case of beer, it is important to ensure that the equipment is kept clean to prevent the beer becoming contaminated. In particular, yeast cultures such as calcium oxalate tend to accumulate in the beer lines and can therefore contaminate beer as it is fed to the beer tap. Recent studies have shown that calcium oxalate and other such contaminants can have a serious effect on the health of the consumer. In particular, studies have shown links to conditions such as breast cancer, and kidney stones.

As the build up of yeast culture begins almost immediately after beer is first fed through the beer line, regular cleaning of the beer line is required. In general, the frequency with which cleaning occurs is controlled by the owner of the establishment, with breweries having little opportunity to monitor the cleaning frequency, and therefore impose standards. This again can therefore have an impact on the quality of the product being dispensed, which again can reflect badly on the brewery, as well as the establishment.

Typically, when the line needs to be cleaned, the operator must uncouple the keg connector from the keg, and then couple the keg connector to a supply of cleaning solution, such that the cleaning solution is pumped through the line to thereby clean the line. When the cleaning process is complete, the keg connector can be reconnected to the keg.

Following cleaning, the line will include a remaining portion of cleaning solution, and this is generally flushed out by dispensing a substantial amount of the liquid from the keg. Similarly, when the keg connector is connected to a cleaning solution supply, a quantity of fluid may remain in the line and this is again typically wasted as cleaning solution is pumped into the line. As a result as much as forty litres of beer (depending on the length and quantity of the lines) is wasted per cleaning operation.

These systems further require manual intervention in order to monitor whether cleaning of the line is required. This is an inaccurate and tedious method of determining whether the line requires cleaning, and can lead to problems associated with dispensing contaminated liquid from a keg.

In the case of dispensing drinks where mixing is required, such as Coca Cola, this is often achieved using a pump system which supplies a stream of soda water and a stream of soft drink syrup through a nozzle so as to mix the streams and form the desired drink. The system is actuated using a simple on/off switch that activates the nozzles for a predetermined amount of time. Controlling the relative flow rates of the two streams controls the correct ratio of syrup to soda water. This is usually achieved by having a flow valve positioned in a flow path from a respective reservoir.

However, the flow rate control valves can be manually adjusted relatively easily. This allows owners of the establishment to adjust the ratio of syrup to soda water thereby altering the drink's quality. This can be done to reduce cost but will result in a lower quality of product. Furthermore, there is no manner of checking the amount of syrup used, or whether alternative syrups have been used instead. This again represents a problem for ensuring product standards. Finally, the machines require manual operation, thereby requiring attention from an operator throughout the duration of the drink pouring operation.

Similarly, in the case of spirits, the barman has to use a measure, such as optics or a shot measure, to ensure the correct volume of drink is prepared. This is time consuming as it means the barman must prepare each drink individually in sequence.

This problem is further exacerbated when drinks are to be formed from a selection of different components, such as a combination of spirits and soft drinks, where use of a number of different manually operated dispensing systems are used.

It is also known to display content, such as advertising or the like, in a range of different locations or venues, such as pubs, shops, or the like. In one example, this is achieved by presenting dynamic content on a suitable display device, such as a TV screen. In such situations, the presented content is typically predetermined and may therefore be based on a suitable playlist or other schedule.

Thus, in its simplest form, this can be achieved using a DVD, or other suitable media, which includes a sequence of adverts thereon. In this case each of the adverts are then displayed in turn by playing the DVD content. In more complex systems, this can be achieved using a network architecture, with adverts or other content being downloaded to displays based on a schedule. This allows a central resource to control the presentation of the adverts by creating a suitable schedule for selecting which content is presented centrally. This is usually performed on the basis of advertisers requirements, allowing the advertiser to pay for adverts to be displayed at specific locations in defined time periods.

However, the control of the displayed content is centrally controlled via a pre-set schedule. Thus, whilst the schedule can be generated to try and maximise the effectiveness of the advertising, the advertising is still pre-set, and may therefore be of little relevance to individuals in the respective venue. As a result, the content is typically of only limited appeal to consumers, and as a result, only has limited effectiveness.

### SUMMARY OF THE PRESENT INVENTION

In a first broad form the present invention provides apparatus for dispensing drinks formed from a number of drink components, the valve including:
a) a housing;
b) a number of inlets for coupling to respective drink component sources in use;
c) a number of outlets, each outlet being coupled to a respective inlet via a respective flow path;
d) a number of flow controllers, each flow controller being provided in a respective flow path for controlling the supply of the respective drink component.

Typically the apparatus includes a number of rate controllers, each rate controller being provided in a respective flow path for controlling the rate of flow of the respective drink component; and,

Typically each rate controller is formed from a moveable flow member adapted to selectively partially block the corresponding flow path.

Typically each flow controller is formed from:
a) a valve seat provided in the flow path; and,
b) a piston, the piston being moveable between:
   i) an extended position in which the piston engages the valve seat to thereby block the flow path; and,
   ii) a retracted position in which the piston is disengaged from the valve seat to thereby allow flow of the drink component through the flow path.

Typically the apparatus includes:
a) a first housing, the inlets being mounted in the first housing; and,
b) a second housing, the outlets being mounted in the first housing, and the flow paths extending from the first housing to the second housing.

Typically the apparatus includes a number of first and second inlets coupled to corresponding first and second outlets via respective first and second flow paths.

Typically the flow controllers for the first flow path are provided in the first housing and the flow controllers for the second flow paths are provided in the second housing.

Typically the apparatus further includes a controller, the controller being coupled to each of the flow controllers to thereby control flow of the respective drink components.

Typically the controller includes:
a) at least one input for allowing selection of a drink;
b) a processing system for:
   i) determining the volume of each drink component required; and,
   ii) generating control signals for selectively activating the flow controllers to thereby dispense the required volume of the required drink components.

Typically the controller includes a flow meter coupled to each drink component source, processing system generating the control system in accordance with signals from the flow meters.

Typically the flow meters are pulse turbines, and wherein the processing system is adapted to control the volume of a drink component dispensed by:
a) activating the respective solenoid;
b) monitoring for a predetermined number of pulses from the respective turbine; and,
c) deactivating the respective solenoid.

Typically the processing system is a programmable logic controller.

Typically the apparatus is adapted to dispense at least twelve drink components.

Typically the apparatus is adapted to dispense at least five spirit drink components, at least six soft drink components and at least one milk drink component.

Typically the housing further includes a coolant flow path for receiving chilled fluid to thereby cool the housing.

In a second broad form the present invention provides apparatus for controlling the dispensing drinks formed from a number of drink components, the dispensing being performed by a valve having:
a) a housing;
b) a number of inlets for coupling to respective drink component sources in use;
c) a number of outlets, each outlet being coupled to a respective inlet via a respective flow path;
d) a number of flow controllers, each flow controller being provided in a respective flow path for controlling the supply of the respective drink component, the apparatus being formed from a processing system having:
   i) an input for receiving a drink selection;
   ii) a store for storing drink data representing the determining the volume of each drink component required; and,
   iii) a processor for generating control signals for selectively activating the flow controllers to thereby dispense the required volume of each required drink component.

In a third broad form the present invention provides a connector for coupling a keg to a line, the connector including:
a) a housing defining a cavity, the housing including:
   i) an inlet for receiving fluid from the keg;
   ii) an outlet for coupling to the line;
   iii) a gas inlet for receiving gas from a gas source;
   iv) a gas outlet for supplying gas to the keg; and,
   v) a cleaning solution inlet for receiving cleaning solution from a cleaning solution supply; and,
b) a shuttle moveably mounted within the cavity, the shuttle including one or more flow paths; and,
c) an actuator for moving the shuttle between a number of operative positions to thereby perform at least one of:
   i) cleaning the line by interconnecting the cleaning solution inlet and the outlet;
   ii) dispensing fluid from the keg by:
      (1) interconnecting the gas inlet and the gas outlet; and,
      (2) interconnecting the inlet and the outlet; and,
   iii) flushing the line by interconnecting the gas inlet and the outlet.

Typically the actuator includes:
a) a gas cylinder for coupling to a gas supply;
b) an arm coupled to the gas cylinder and the shuttle; and,
c) a solenoid for controlling the supply of gas to the gas cylinder to thereby control the position of the arm.

Typically the gas inlet and the gas cylinder are coupled to a common gas supply.

Typically the actuator arm is mounted to a piston provided in the gas cylinder.

Typically the shuttle includes at least one protrusion, and wherein in use, the protrusion cooperates with a valve in the keg to thereby allow fluid to be dispensed.

Typically in use, the actuator is coupled to a controller, the controller being adapted to control the actuator to thereby selectively move the shuttle between the operative positions.

Typically the controller is formed from a suitably programmed processing system.

Typically, in use, if the line is to be cleaned, the controller operates to:
a) move the shuttle to a third operative position to cause cleaning of the line;
b) move the shuttle to a second operative position to flush the cleaning fluid from the line; and,
c) move the shuttle to the first operative position to allow fluid to be dispensed.

Typically, in use, the controller operates to move the shuffle to the second operative position to dispense any fluid in the line before moving the shuttle to the third operative position to cause cleaning of the line.

Typically the controller is coupled to one or more sensors for determining at least one of:
a) if the connector is coupled to a keg;
b) if the line requires cleaning;
c) the volume of fluid dispensed;
d) determining the presence of fluid in the line;
e) the pressure of gas supplied to at least one of the actuator and the gas inlet; and,
f) operation of the actuator.

Typically the controller:
a) determines the presence of a keg;
b) in response to a positive determination, moves the shuttle to a first operative position to allow fluid to be dispensed;
c) monitors the amount of fluid dispensed; and,
d) in response to the amount exceeding a predetermined threshold, causes the line to be cleaned.

Typically the amount includes at least one of a fluid volume or a fluid dispensing time.

Typically the controller includes a display for displaying at least one of:
a) the amount of fluid dispensed;
b) operating instructions;
c) one or more errors in operation; and,
d) the amount of fluid to be dispensed before the next cleaning operation.

Typically the controller: p1 a) receives indicating data from one or more sensors, the indicating data being indicative of one or more operating parameters;
b) compares the operating parameters to one or more predetermined parameter ranges; and,
c) determines an operational error in response to an unsuccessful comparison.

Typically the operational parameters include at least one of:
a) the shuffle position;
b) the amount of fluid dispensed;
c) the gas pressure; and,
d) the presence of fluid in the line.

In a fourth broad form the present invention provides a controller for use with a connector, the connector being adapted to couple a keg to a line, and being connected to a cleaning solution supply and a gas supply, the connector including a shuttle moveable between a number of operative positions, the controller including a processing system for selectively moving the shuttle between the operative positions to thereby perform at least one of:
a) cleaning the line by supplying cleaning solution to the line;
b) dispensing fluid from the keg by supplying gas to the keg to thereby pressurise the keg; and,
c) flushing the line by supplying gas to the line.

Typically the controller is adapted to perform a cleaning cycle by:
a) moving the shuttle to a third operative position to cause cleaning of the line;
b) moving the shuttle to a second operative position to flush the cleaning fluid from the line; and,
c) moving the shuttle to the first operative position to allow fluid to be dispensed.

Typically, in use, the controller operates to move the shuffle to the second operative position to dispense any fluid in the line before moving the shuttle to the third operative position to cause cleaning of the line.

Typically the controller is coupled to one or more sensors for determining at least one of:
a) if the connector is coupled to a keg;
b) if the line requires cleaning;
c) the volume of fluid dispensed;
d) determining the presence of fluid in the line;
e) the pressure of gas at the gas inlet; and,
f) operation of the actuator.

Typically the controller:
a) determines the presence of a keg;
b) in response to a positive determination, moves the shuttle to a first operative position to allow fluid to be dispensed;
c) monitors the amount of fluid dispensed; and,
d) in response to the amount exceeding a predetermined threshold, causes the line to be cleaned.

Typically the amount includes at least one of a fluid volume or a fluid dispensing time.

Typically the controller includes a display for displaying at least one of:

a) the amount of fluid dispensed;

b) operating instructions;

c) one or more errors in operation; and,

d) the amount of fluid to be dispensed before the next cleaning operation.

Typically the controller:
a) receives indicating data from one or more sensors, the indicating data being indicative of one or more operating parameters;
b) compares the operating parameters to one or more predetermined parameter ranges; and,
c) determines an operational error in response to an unsuccessful comparison.

Typically the operational parameters include at least one of:
a) the shuttle position;
b) the amount of fluid dispensed;
c) the gas pressure; and,
d) the presence of fluid in the line.

In a fifth broad form the present invention provides a method presenting content, the method including, in a processing system:
a) determining content including:
   i) schedule content; and,
   ii) trigger content;
b) determining control data for controlling the presentation of content, the control data including:
   i) a schedule for controlling the presentation of the schedule content; and,
   ii) indications of one or more triggers associated with the trigger content; and,
c) causing the scheduled content to be presented on a display in accordance with the schedule;
d) monitoring for one or more triggers; and,
e) in response to the detection of a trigger:
   i) interrupting the presentation of schedule content; and,
   ii) causing trigger content associated with the respective trigger to be presented on the display.

Typically the method includes, in the processing system, and in response to the presentation of trigger content, updating the schedule.

Typically the method includes, in the processing system:
a) determining a priority of one or more content items from the schedule; and,
b) removing one or more content items from the schedule in accordance with the determined priority.

Typically the method includes, in the processing system, updating the schedule in accordance with at least one of:
a) the relative size of the scheduled content items and the presented trigger content;
b) the nature of the scheduled content items and the presented trigger content;
c) the content provider or advertiser of the scheduled content items and the presented trigger content; and,
d) the order of the scheduled content items in the schedule.

Typically the processing system is coupled to one or more sensors, and wherein the method includes determining the one or more triggers in response to one or more signals received from the sensors.

Typically the sensors include at least one of:
a) a barcode reader;
b) an electronic input;
c) a processing system input;
d) a system for receiving a communications message; and,
e) a motion sensor for detecting the movement of a product item.

Typically the triggers are indicative of at least one of:
a) Product handling;
b) SMS messages;
c) MMS messages;
d) Biometric sensing;
e) RFID interactions;
f) GPRS information;
g) ATM interaction;
h) Touch screen information; and,
i) Lift buttons.

Typically the method includes, in the processing system:
a) determining feedback in response to the presentation of trigger content; and,
b) performing one or more response actions associated with the feedback.

Typically the method includes, in the processing system, determining the one or more response actions from the control data.

Typically the method includes, in the processing system, receiving at least one of the content and the control data from a base station.

Typically the method includes, in the processing system:
a) determining indicating data indicative of the displayed content; and,
b) causing the indicating data to be used in determining one or more of:
   i) accounting data representing accounts associated with the presentation of content; and,
   ii) analysis results indicative of an analysis of the indicating data.

Typically the method includes, in the processing system, transferring the indicating data to a base station, the base station being responsive to the indicating data to determine at least one of the accounting data and the analysis results.

Typically the displays are at least one of:
a) part of the processing system; and,
b) coupled to the processing system.

Typically the method includes, in the processing system:
a) determining the next scheduled content to be displayed; and,
b) transferring the content to the display, thereby causing the display to present the respective content.

In a sixth broad form the present invention provides apparatus for presenting content, the apparatus including a processing system for:
a) determining content including:
   i) schedule content; and,
   ii) trigger content;
b) determining control data for controlling the presentation of content, the control data including:
   i) a schedule for controlling the presentation of the schedule content; and,
   ii) indications of one or more triggers associated with the trigger content; and,
c) causing the scheduled content to be presented on a display in accordance with the schedule;
d) monitoring for one or more triggers; and,
e) in response to the detection of a trigger:
   i) interrupting the presentation of schedule content; and,
   ii) causing trigger content associated with the respective trigger to be presented on the display.

Typically the apparatus includes one or more sensors coupled to the processing system, the processing system being responsive to signals from the sensors to thereby determine one or more triggers.

Typically the apparatus includes one or more displays, the displays being at least one of:
a) part of the processing system; and,
b) coupled to the processing system via a communications link.

Typically the processing system is coupled to a base station via a communications network, the processing system being for receiving the control data and the content from the base station.

In a seventh broad form the present invention provides a method of causing presentation of content, the method including, in a base station:
a) determining content including:
   i) schedule content; and,
   ii) trigger content;
b) determining control data for controlling the presentation of content, the control data including:
   i) a schedule for controlling the presentation of the schedule content; and,
   ii) indications of one or more triggers associated with the trigger content; and,
c) transferring the content and the control data to one or more end stations, each end station being responsive to:
   i) cause the scheduled content to be presented on a display in accordance with the schedule;
   ii) monitor for one or more triggers; and,
   iii) in response to the detection of a trigger:
      (1) interrupt the presentation of schedule content; and,
      (2) cause trigger content associated with the respective trigger to be presented on the display.

Typically the method includes, in the base station:
a) receiving details of the content to be displayed; and,
b) using the received details to generate at least one of:
   i) the content; and,
   ii) the control data.

Typically the method includes, in the base station:
a) determining one or more response actions associated with the trigger content; and,
b) generating the control data in accordance with the response actions.

Typically the method includes, in the base station:
a) receiving indicating data from the one or more end stations; and,
b) determining from the indicating data, the displayed content.

Typically the method includes, in the base station, using the indicating data to determine at least one of:
i) accounting data representing accounts associated with the presentation of content; and,
ii) analysis results indicative of an analysis of the indicating data.

In an eighth broad form the present invention provides apparatus for causing presentation of content, the apparatus including a base station for:
a) determining content including:
   i) schedule content; and,
   ii) trigger content;
b) determining control data for controlling the presentation of content, the control data including:
   i) a schedule for controlling the presentation of the schedule content; and,
   ii) indications of one or more triggers associated with the trigger content; and,
c) transferring the content and the control data to one or more end stations, each end station being responsive to:
   i) cause the scheduled content to be presented on a display in accordance with the schedule;
   ii) monitor for one or more triggers; and,
   iii) in response to the detection of a trigger:
      (1) interrupt the presentation of schedule content; and,
      (2) cause trigger content associated with the respective trigger to be presented on the display.

It will be appreciated that the broad forms of the invention may be used in conjunction.

### BRIEF DESCRIPTION OF THE DRAWINGS

An example of the present invention will now be described with reference to the accompanying drawings, in which:

FIG. 1 is a schematic diagram of an example of a drink dispensing system;

FIG. 2 is a schematic diagram of the processing system used in FIG. 1;

FIG. 3 is a schematic diagram of an ID tag and tag reader suitable for use in drinks dispensing systems;

FIG. 4 is a schematic diagram of a control valve for use in the system of FIG. 3;

FIGS. 5A to 5D are schematic diagrams of examples of pistons for use in the control valve of FIG. 4;

FIG. 6 is a schematic diagram of the control valve of FIG. 4 mounted to the dispensing system of FIG. 3;

FIGS. 7A to 7D are schematic diagrams of an example of a keg connector in coupling, first, second and third positions respectively;

FIG. 8 is a flowchart of an overview of the process of controlling operation of the keg connector;

FIGS. 9A and 9B are a flow chart of an example of using the keg connector for cleaning a beer line;

FIG. 10 is a perspective exploded view of an example of a valve for dispensing drinks;

FIG. 11 is a perspective view of the valve of FIG. 10;

FIG. 12A to 12C are plan, front and side views of the valve of FIG. 10;

FIG. 13A is a perspective view of the inlet housing of FIG. 10;

FIG. 13B is a cross sectional view of the inlet housing of FIG. 13A along the line A-A′;

FIG. 13C is a cross-sectional view of the inlet housing of FIG. 13A along the line B-B′;

FIGS. 14A and 14B are perspective and plan views of the outlet housing of FIG. 10;

FIGS. 15A to 15D are a plan, underside, side and cross sectional views of the outlet of FIG. 10;

FIG. 16 is a schematic diagram of a control system for use with the valve of FIG. 10.

FIG. 17 is a flow chart outlining an example of a process of presenting context dependent content;

FIG. 18 is a schematic diagram of an example of a distributed architecture for use in drink dispensing; and,

FIGS. 19A to 19C are a flow chart of an example of the process for presenting context dependent content.

### DETAILED DESCRIPTION OF THE PREFERRED EMBODIMENTS

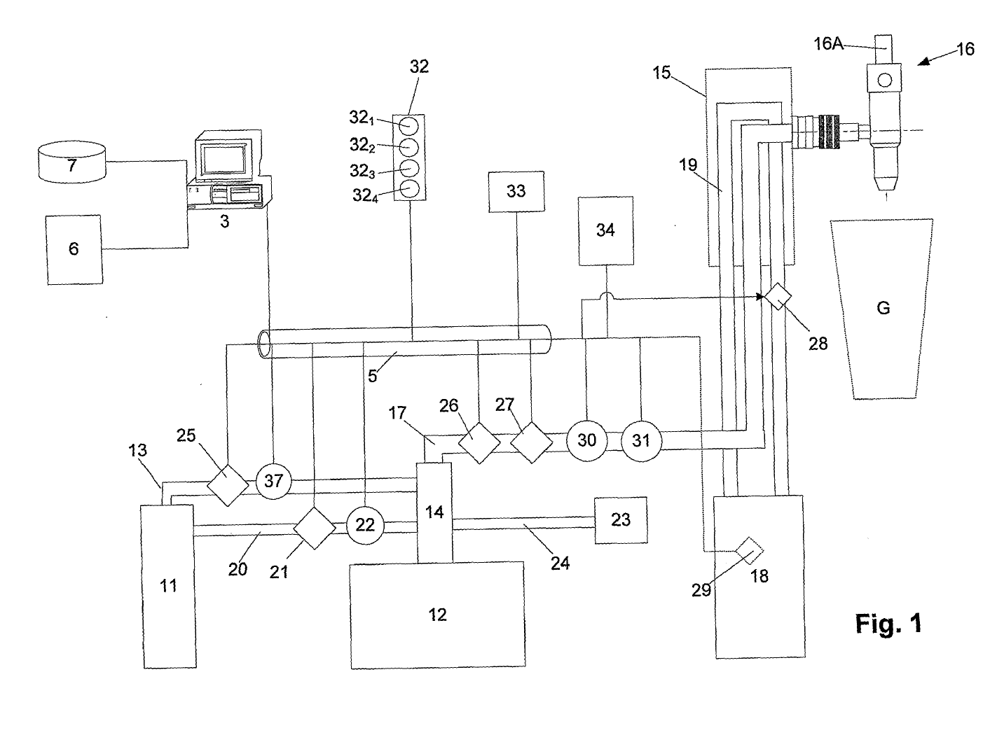

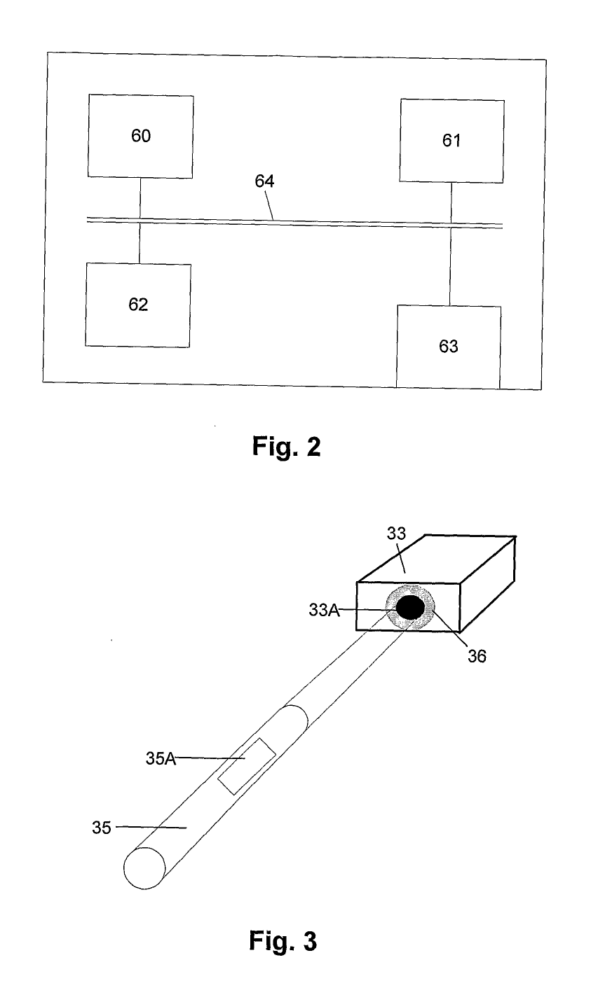

An example of a system for dispensing chilled fluids, such as drinks, will now be described with reference to FIGS. 1 and 2. The following examples will be described with reference to the dispensation of beer, but it will be appreciated that the techniques may be applied to any chilled, pressurised fluid.

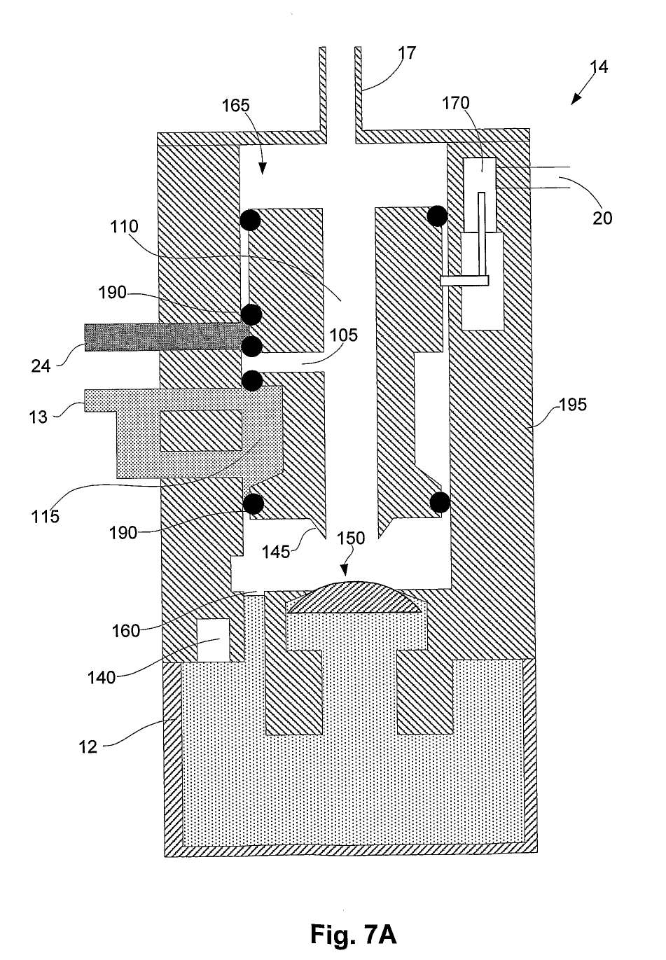

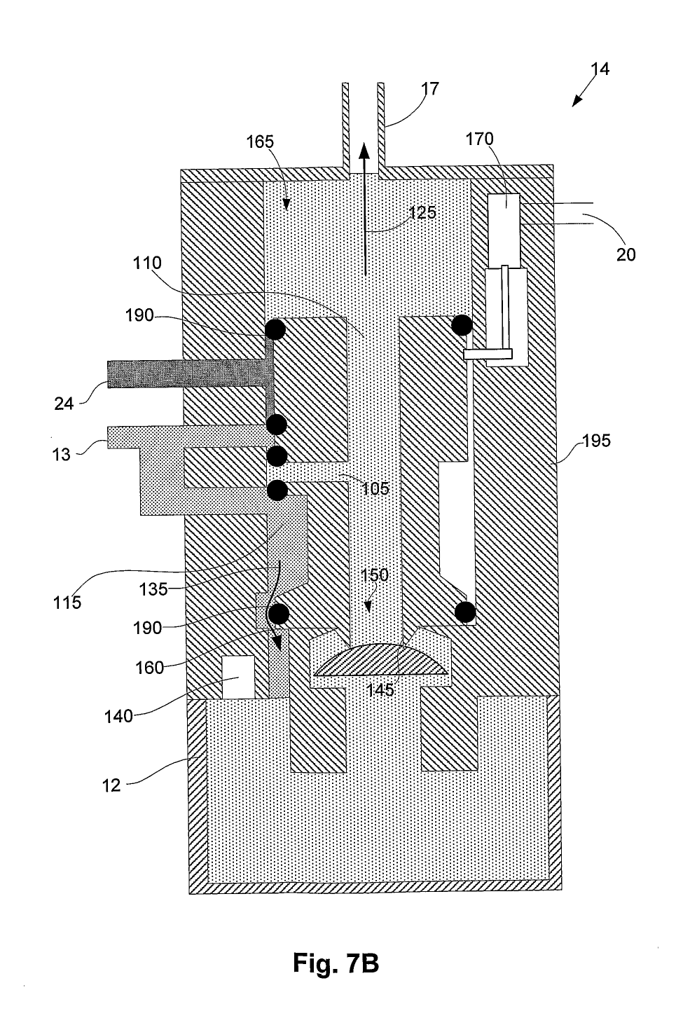

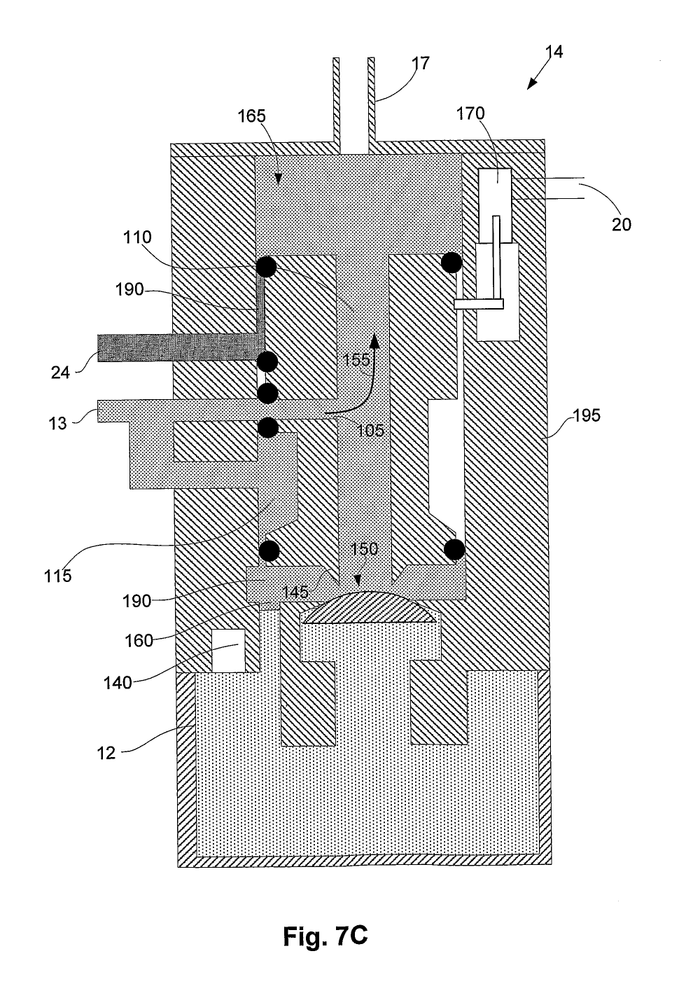

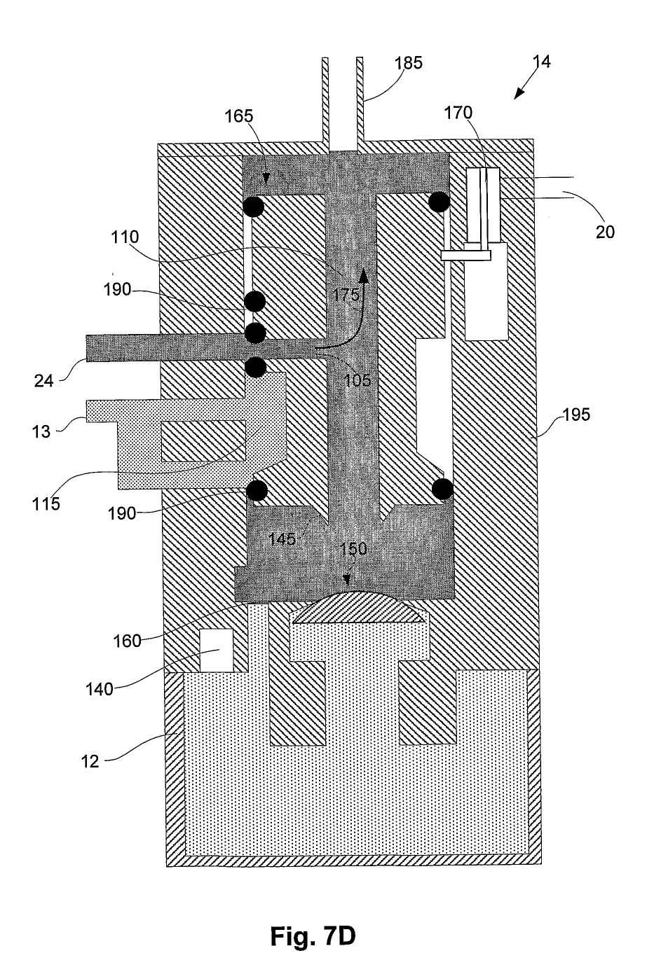

The system includes a gas supply 11 coupled to a beer supply 12, which is typically in the form of a beer barrel or keg, via a gas pressure line 13 and an appropriate keg connector 14, which will be described in more detail below with respect to FIGS. 7 to 10.

The keg connector 14 may also be coupled to a cleaning solution reservoir 23, via a cleaning solution line 24, and to the gas supply 11, via a second gas supply line 20, depending on the implementation.

The keg connector 14 is also coupled to a dispensing unit 15 including a beer tap 16, via a beer line 17. A coolant supply 18 is provided to cool the beer in the beer line. This is achieved by pumping a coolant, such as glycol, through a coolant line 19, which is positioned in thermal contact with the beer line 17, to thereby cool the beer contained therein. The beer line 17 and the coolant line 19 are typically contained in a python, which is an insulated pipe covering, between the coolant supply 18 and the dispensing unit 15. A chiller plate is then provided in the dispensing unit, to ensure the beer is sufficiently cooled prior to being dispensed, as will be appreciated by a person skilled in the art.

In use, the beer tap typically includes a handle 16A, which allows an operator to open the beer tap and thereby dispense a beer into a drinks receptacle, such as a glass G, in the normal way. Thus, opening the tap will cause beer under pressure to flow along the beer line 17 into the glass G.

A processing system 3 is connected to a flow meter 30, and a control valve 31, provided in the beer line 17, as well as to a number of input buttons 32, an optional tag reader 33, and optional displays 34. These connections may be wired, for example through the use of an Ethernet LAN (Local Area Network) shown generally at 5, or through wireless connections, for example via use of Bluetooth connections, or the like.

The processing system uses the flow meter 30 and the control valve 31 to control the dispensing of drinks. This allows user's of the system to select a desired size of drink, using either the processing system 3, or one of the buttons 32, and then have the selected drink automatically dispensed by the processing system 3.

The processing system can also be coupled to gas pressure sensors 21, 25 and gas control valves 22, 37, provided in the gas pressure lines 20, 13, allowing the keg connector to be controlled, for example to allow automated cleaning of the beer line 17.

An example of a suitable processing system is shown in more detail in FIG. 2. As shown the processing system 3 includes a processor 70, a memory 71, an input/output (1/0) device 72, such as a keypad and display, and an external interface 73, which are coupled together via a bus 74.

The interface 73 is designed to allow the processing system to communicate via the communications network 5, and optionally with other processing systems, and accordingly the type of the interface 73 will depend on the nature of the communications network. Thus for example, if the communications network is an Ethernet LAN, the interface may be an Ethernet card, or the like. Alternatively, direct connections may be provided to the processing system 3, in which case the network will be replaced with simple connections, which may be wired or wireless.

It will therefore be appreciated that the processing system may be any form of suitable processing system 3, such as a suitably programmed computer, lap-top, palm-top, mobile phone with suitable processing capabilities, predetermined hardware, or the like.

When dispensing drinks, the user, such as a barman or the like will place an appropriate sized receptacle G under the beer tap 16, and selects one of the input buttons 32₁, 32₂, 32₃, 32₄. In use, each button 32₁, 32₂, 32₃, 32₄ corresponds to a respective size of drink, and this therefore allows the user to select a drink size at the touch of a button.

In any event, the processing system 3 will detect the button 32₁, 32₂, 32₃, 32₄ selected by the user and use this information to access a look-up table (LUT) stored in the memory 71. The LUT will indicate for specific buttons, the size of the drink that is to be dispensed, and in particular, the drink volume. It will be appreciated that this information may be stored and optionally encoded or encrypted in the memory 71 by a machine supplier, thereby preventing its alteration by the user. Alternatively the volume information may be input by an owner of the system.

In any event, this will cause the processing system 3 to selectively activate the control valve 31, to dispense the required volume of beer. This is achieved by having the processing system 3 generate a signal which is applied to the control valve 31, thereby causing it to open and shut as required (this will hereinafter be referred to as the “control signal”).

Signals generated by the flow meter 30 (hereinafter referred to as “flow signals”) are monitored by the processing system 3 to determine the volume of drink that has been dispensed. Once the required drink volume is dispensed, the processing system 3 will cause the control valve 31 to close, thereby ending the dispensing process.

Typically the flow meters are turbines, in which case the flow signals include a number of pulses, with each pulse representing a predetermined volume of drink dispensed. The processor 70 therefore counts the number of pulses generated by the turbine, and compare this to a predetermined number of pulses stored in the LUT, which therefore defines the volume of the selected drink. When the predetermined number of pulses are reached, this indicates to the processor that the desired volume of drink has been dispensed, and that the control valve can therefore be shut. Other types of flow meters may however be used, in which case, the method can be adapted accordingly.

In any event, this ensures that the drinks are dispensed automatically in accordance with the predetermined volumes stored in the LUT in the memory 71.

The processing system 3 can also be adapted to prevent drinks being dispensed unless an ID tag has been inserted into a tag reader 33. An example tag reader is shown in FIG. 3.

In this example, the tag reader 33 includes an aperture 33A for receiving the ID tag, shown generally at 35. In this case, the alert unit 34 is formed from an indicator positioned around the aperture 13A, which is adapted to change colour depending on the status of the system. Thus for example, red could be used to indicate that the system is locked or unable to function due to an error, green that the user is authorised to perform the respective function, or yellow if the user is not authorised. It will be appreciated that this allows the user to easily determined any problems.

Accordingly, in this example when a user wishes to order a respective drink the user presents their ID tag, which is typically a radio frequency ID (RFID) tag, to the tag reader 33. The tag reader 33 transfers an indication of an identifier associated with the tag to processor 70. The processor 70 accesses an LUT stored in the memory 71 that lists an identifier for each user associated with each tag. Assuming that the tag is a valid tag associated with the system the processor 70 allows a selected drink to be dispensed in the manner described above.

Each user may have an associated access control level, which defines operations the user is able to perform. Thus, for example some staff members can be authorised to provide promotional free drinks to patrons. Other operators, in addition to their normal duties, may be authorised to correct mistakes or errors of other staff members. The level of authorisation can be very diverse. For example other staff operator can only dispense non alcoholic beverages etc, allowing different types of staff to use the machine for dispensing alcoholic and non alcoholic drinks as may be required in some jurisdictions.

Thus, the processing system 3 can determine the access level of the user. When the user selects an action to be performed, such as selecting a drink to be dispensed using one of the input buttons 32, the processing system 3 will determine if the user is authorised to perform this function in accordance with the defined access level.

Thus, for example, if a user inserts their ID tag 35 into the tag reader 33, the processing system 3 will determine if the user is authorised to use the system, and if so, then cause the alert unit to provide a green indication. If the user subsequently makes an unauthorised selection, such as the selection of an alcoholic drink when the user is only allowed to dispense non-alcoholic drinks, the processing system 3 will cause the alert unit 34 to provide a yellow indication, and the drink will not be dispensed.

Finally, if the system is locked, or a fault occurs, such as an empty barrel, or signals from the sensors 25, 26, 27. 28, 29, fall outside the predetermined operating range, the alert unit 34 will provide a red indication. In this case, the processing system 3 may be adapted to provide additional details of the fault on the I/O device 72.

It will be appreciated that a number of variations on the above described ID tag 35 may be implemented. Thus, for example, the form of the ID tag may vary from that shown, so that the ID tag is in the form of a wearable ring or band, such as a wrist band. In this case, the tag reader 33 may not need an aperture, but rather will simply be adapted to detect when a respective ID tag is placed near or in contact with the tag reader. Other forms of physical arrangement of the ID tag may be used.

The ID tags may also work on systems other than RFID systems, such as through the use of electrical contacts between the ID tag and the tag reader 33, which are used to transfer data from the tag memory, through wireless data transfer protocols, such as Bluetooth or the like. This increases the number of different types of identifier that can be used. Thus, for example, the tag reader 33 may be adapted to interrogate any remote device, such as a mobile phone or the like, to download an identifier therefrom, allowing this to be used to identify the user.

Physical devices such as keys may be provided to open an associated lock, with this action indicating to the processing system 3 that the user is an authorised user.

Finally, alternative systems can be used for identifying users, other than ID tags. Thus, for example, each user may have a unique identifier that is input into the system in some fashion. This may be for example similar to a PIN (personal identification number) or password and may be supplied to the processing system 3 via an appropriate keypad, such as the I/O device 72, or a separate keypad provided instead of the tag reader.

Similarly, the tag reader could be replaced with a device for determining biometric information from the users, such as a thumb-print, finger-print, iris scan or the like. In any event, any technique may be used as long as this allows the user of the system to uniquely identify themselves to the processing system 3.

In the example shown in FIG. 1, the dispensing unit 15 includes a manual beer tap 16. It will be appreciated that this provides the user with additional manual control of the dispensing of the beer, thereby allowing the user to control the size of the beer head, or the like. In any event, this is not essential to the invention, as the system can provide sufficient automated control, and the beer tap 16 can therefore be replaced with a simple outlet, as will be appreciated by persons skilled in the art.

The system can also incorporate additional flow rate control mechanisms, such as adjustment screws. However, alteration of the flow rate will not effect the operation of the system, as the volume of drink dispensed is measured.

In the example described above, the control valve 31 can be positioned at any location in the beer line. However, to obtain exact control of the flow of fluid out of the beer line, it is preferable for the control valve 31 to be positioned as close to the outlet or tap as possible.

It will therefore be appreciated that this may make the control valve 31 difficult to fit to existing systems in some circumstances. In particular, in many pubs and clubs, drinks such as beer are supplied via a font including the beer tap 16 and chiller plate. These systems cannot easily be modified to allow for incorporation of a control valve 31 under normal circumstances.

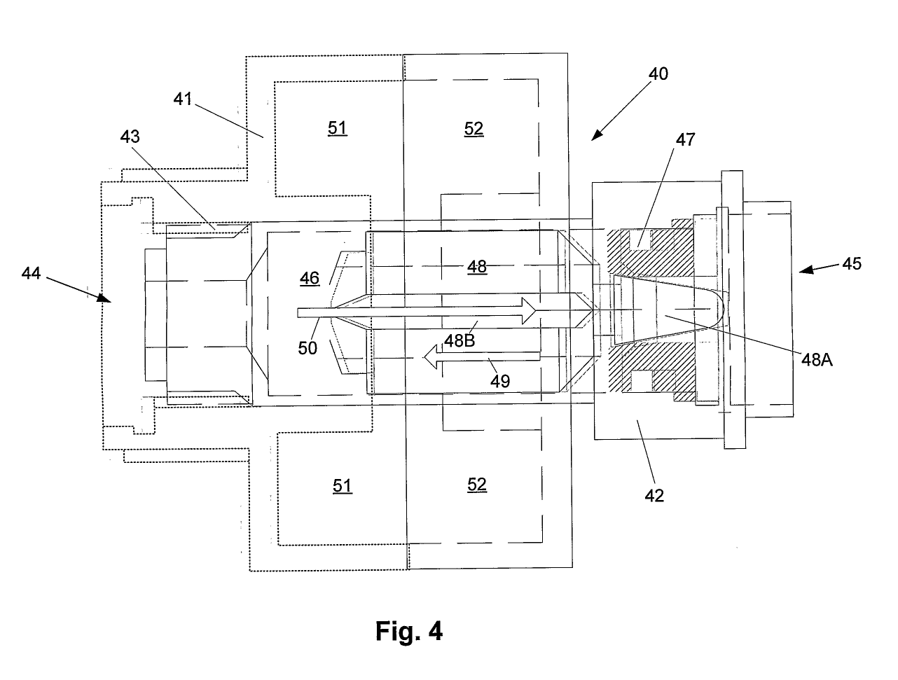

Accordingly, an example of an control valve 31 adapted for use in such an arrangement is shown in FIG. 4. In particular, as shown, the valve includes a housing 40, formed from first and second portions 41, 42 (the first portion being shown in dashed lines for clarity purposes) coupled together via an appropriate fixing 43, such as a screw fitting, or the like. The first housing portion 41 includes a font fitting 44 for coupling to the font or beer dispensing unit 15, whereas the second housing portion 42 includes a tap fitting 45, for coupling to the beer tap 16.

The housing 40 defines a cavity 46, including a valve seat 47 (shown cross hatched for clarity), and a piston 48 mounted therein. The piston 48, is adapted to move along the cavity 46 as shown by the arrow 49. The piston includes a shaped seal 48A, such that when the piston 48 is in the position shown in FIG. 4, the seal 48A cooperates with the valve seat 47, to seal the cavity from the beer tap 16.

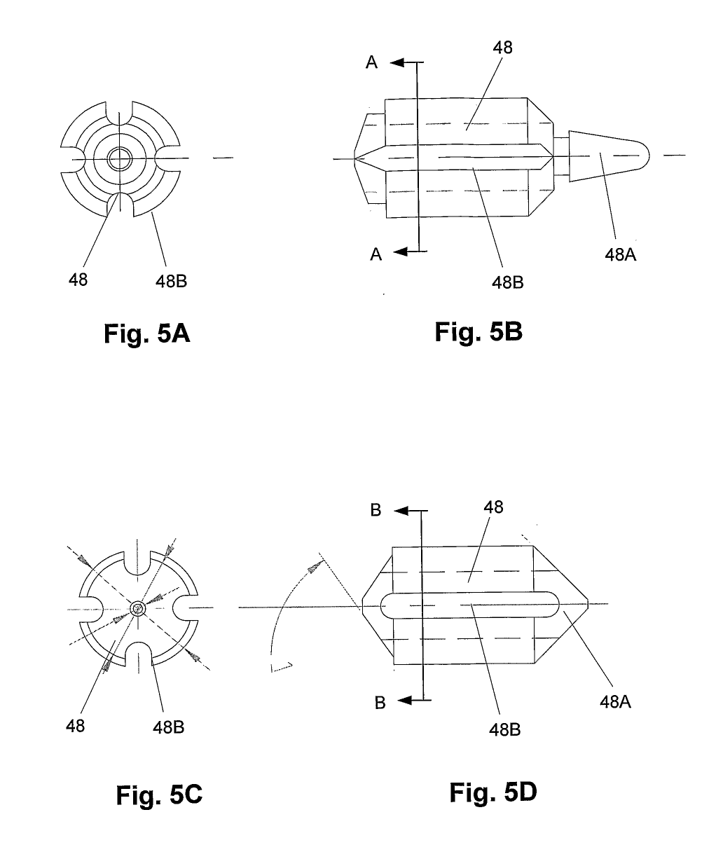

Examples of suitable pistons are shown in FIGS. 5A to 5D. In particular, FIG. 5A shows a cross sectional view of the piston shown in FIG. 5B, along the line A-A. In this example, the piston includes a number of channels 48B, which are adapted to allow beer to flow through the cavity 46 from the dispensing unit 15 to the beer tap 16 and past the piston 48, as shown by the arrow 50. An alternative piston design is shown in FIGS. 5C and 5D, and it will be appreciated that this design piston is adapted to cooperate with a respective design of valve seat 47.

It will therefore be appreciated that a number of different valve designs could be used. Thus for example, the piston could be replaced by a shuttle valve, or the like, as will be appreciated by persons skilled in the art.

A solenoid coil 52 is mounted to the housing portion 41. The piston will be magnetic to allow the position of the piston 48 to be controlled using the solenoid coil 51. In particular, in use the valve is coupled to the dispensing unit 15 so that the cavity 46 is coupled to the beer line 8 and will be filled with beer under pressure. The piston 48 is therefore urged against the valve seat 47, causing the cavity 46 to be sealed.

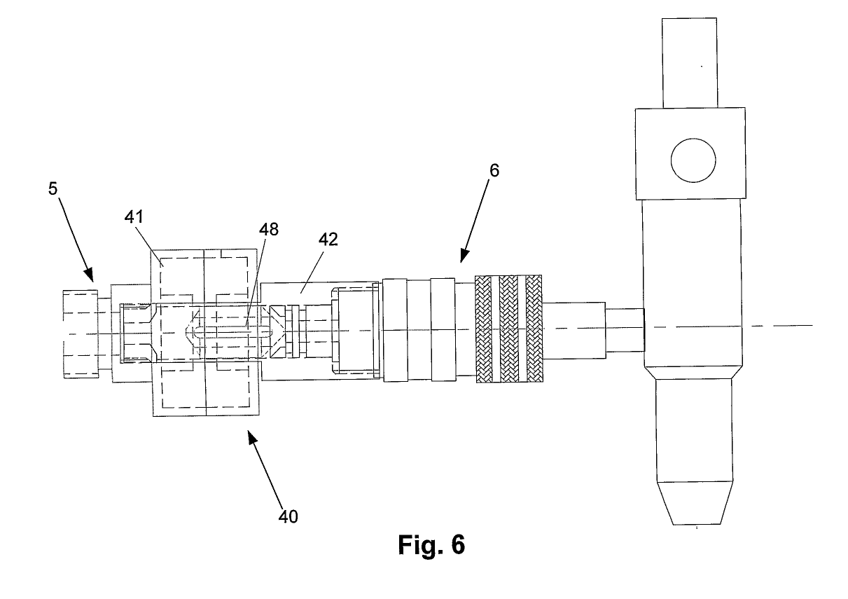

In use, the control valve 31 can be fitted to an existing beer dispensing system by removing the beer tap 16 from the dispensing unit 15 or font, and coupling the font fitting 44 to the font, and the beer tap 16 to the tap fitting 45. An example of the constructed system is shown in FIG. 6. Once this has been completed, the solenoid coils will be connected with the processing system 3, via an appropriate interface, such as a driver circuit, and a flow meter 30 will be fitted as required.

When beer is to be dispensed, the processor 70 will cause a current to be applied to the solenoid coil 51, thereby attracting the piston in the direction of the arrow 49. This in turn releases the seal, allowing beer to flow from the cavity 46 through the channels 48B into the beer tap 16, allowing the beer to be dispensed. The processing system 3 monitors signals from the flow meter 30 and determines when the required quantity of drink has been dispensed, as described above.

The processing system 3 can then simply deactivate the current supplied to the solenoid coil 51, allowing the flow of the beer through the cavity 46, to urge the piston 48 into sealing engagement into with the valve seat 47, thereby deactivating the dispensation of the beer.

Whilst resealing of the cavity may be performed solely by the action of the beer flow, it is preferable to ensure a fast on and off action to the control valve 31. Accordingly, a second coil 52 may be provided to attract the piston in the direction of the arrow 52, thereby urging the piston 41 back into sealing engagement with the valve seat 47 to obtain a more rapid and reliable shut-off.

It will be appreciated that this arrangement aids the fitting of the control valve 31 to existing systems, thereby allowing the functionality described above to be implemented in the existing systems. In order to further aid with this, the housing 40 may incorporate the flow meter 30.

Additionally, or alternatively, a temperature sensor may be provided to monitor the temperature of the dispensed beer and/or the temperature of the solenoid coils, to thereby prevent overheating. This may be used in addition to, or instead of the temperature sensor coupled to the coolant lines 19. Thus, the beer temperature may also be useful to provide an indication of a fault in the cooling system, with a comparison between the beer temperature sensor and the coolant sensor 26 helping to provide an indication of the cause of the fault.

An example of the keg connector 14 will now be described with reference to FIGS. 7A to 7D.

The keg connector 14 includes a housing 195 defining a cavity 165 containing a shuttle 120. The housing 195 is coupled to the gas pressure line 13, the cleaning solution line 24, and the beer line 17, each of which is in fluid communication with the cavity 165, as shown. A keg inlet 150, and a gas outlet 160 are also provided. The shuttle 120 defines first, second and third flow paths 105, 110, 115, which allow different dispensing operations to be performed when the shuttle 120 is moved between selected operative positions.

A number of seals 190, are attached to an outer surface of the shuttle 120, to sealingly engage the housing 195, to thereby separate the flow paths 105, 110, 115, and selectively couple these to the gas pressure line 13, and the cleaning solution line 24. In this example, the keg connector 14 also includes a keg sensor 140 that detects whether a keg 12 has been coupled to keg connector 14.

An actuator 170 is provided which is coupled to the shuttle 120 to move the shuttle 120 between coupling, first, second and third operative positions, shown in FIGS. 7A to 7D respectively. In this example, the actuator 170 is in the form of a gas-controlled cylinder supplied with pressurised gas from the gas supply 11 via the gas pressure line 20. This is used for displacing the shuttle 120 into an appropriate position. Alternatively, a traditional piston system may be used in order to control the shuttle's position.

In FIG. 7A, the shuttle 120 is shown in a coupling position, which is used as the keg connector 14 is coupled to the keg 12. In particular, the shuttle 120 is positioned such that the first flow path 105 does not align with either the cleaning solution or gas pressure lines 20, 13. In this configuration, neither cleaning solution, gas, or liquid can flow in the keg connector, allowing the keg connector 14 to be coupled to the keg 12. This coupling may use conventional methods such as using a screw thread and nut.

In FIG. 7B, the shuttle 120 is shown in the first operative position. The shuttle 120 is displaced from the coupling position by the actuator 170, such that a protrusion 145 on the shuttle 120 cooperates with the keg inlet 150 to urge the keg inlet 150 into an open position as shown. This leaves a gap between a seal 190 and the housing 195 allowing gas to flow from the gas pressure line 13, via the third flow path 115, and through the gas outlet 160 and into the keg 12, as shown by the arrow 135, thereby pressurising the keg 12. This causes liquid contained within the keg 12 to be urged along the line via the keg inlet 150 and the second flow path 110, to thereby be dispensed via the line 17, as shown by the arrow 125.

FIG. 7C shows the shuttle 120 in the second operative position, with the shuttle 120 displaced so that the first flow path 105 aligns with the gas pressure line 13. This allows for gas to flow into beer line 17 via the third flow path 105, as shown by the arrow 155. This allows the beer tap 16 to be opened thereby dispensing drink remaining in the beer line 17, or flushing out cleaning solution that remains in the line.

FIG. 7D shows the shuffle 120 in the third operative position, with the first flow path 105 aligned with the cleaning solution line 24. This allows for cleaning solution to flow into the beer line 17, via the first flow path 105, as shown by arrow 175, thereby flushing the beer line 17 with the cleaning solution. The beer tap 16 can be opened by an operator to dispense and dispose of a substantial portion of the cleaning solution in the line.

The gas supply 11 supplies gas to the keg connector 14, via the gas pressure line 13, for removing cleaning solution and liquid from the line. A mixture of cleaning solution and water and cleaning solution is supplied to the keg connector 14, via the cleaning solution line 24, from the cleaning solution source 23.

The flow meter 30 measures a volume of liquid dispensed through the beer line 17. A photosensor (not shown) may be used to determine whether the line is empty of cleaning solution or liquid. Both the flow meter 30 and photosensor generate data indicative of a line state, allowing the processing system 3 to determine when the line requires cleaning.

In use, the processing system 3 operates to control the gas pressure provided to the actuator 170, thereby selectively moving the shuttle 120 between the coupling and operative positions described above. This is achieved using the pressure sensor 21 to generate data indicative of the gas pressure in the gas pressure line 20, allowing the processing system 3 to adjust the gas control valve 22, which is typically in the form of a solenoid, to thereby control the shuttle position. The keg connector's keg sensor 140 generates data indicative of whether a keg 12 has been coupled to the keg connector 14, allowing the processing system 3 to determine whether the shuffle 120 is to be moved.

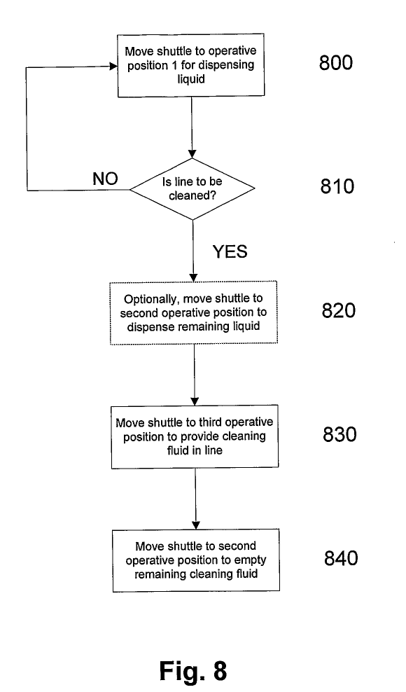

An example of a method for controlling the movement of the shuttle in the keg connector 14 will now be described with reference to FIG. 8.

At step 800 the processing system 3 moves the shuttle 120 to the first operative position for dispensing the liquid from the keg 12. In this example, this can be performed by having the processing system 3 activate the gas control valve 22 so as to supply gas from the gas supply 11 in order to move the shuttle into the first operative position.

At step 810, the processing system 3 determines whether the line requires cleaning. This may be achieved in a number of manners, as will be described in more detail below. If cleaning is not required, the shuttle 120 remains in the first operative position to allow beer to be dispensed. Once the processing system 3 determines cleaning is required, the processing system 3 moves on to step 820.

If optional step 820 is performed by the processing system 3, the shuttle 120 is moved to the second operative position in order to dispense the remaining liquid from the line. This is performed by supplying gas via the gas pressure line 13 so as to force the remaining liquid in the line out. By performing this step, the remaining liquid in the line may be dispensed and used in the normal way.

Shown at step 830, the shuttle 120 is moved to the third operative position to supply cleaning solution to the cleaning solution inlet and hence to the line. The cleaning solution is supplied to force either liquid provided in step 810 or gas provided in step 820 out of the line, as well as to clean the line.

At step 840, the shuttle 120 is moved to the second operative position to empty the remaining cleaning solution from the line. This is performed by feeding gas into the gas pressure line 13 in order to force the remaining cleaning solution out of the line, allowing this to be disposed. At the completion of step 440, the shuttle 120 is moved by the processing system 3 into the first operative position such that liquid in the keg may be dispensed, as shown at step 400.

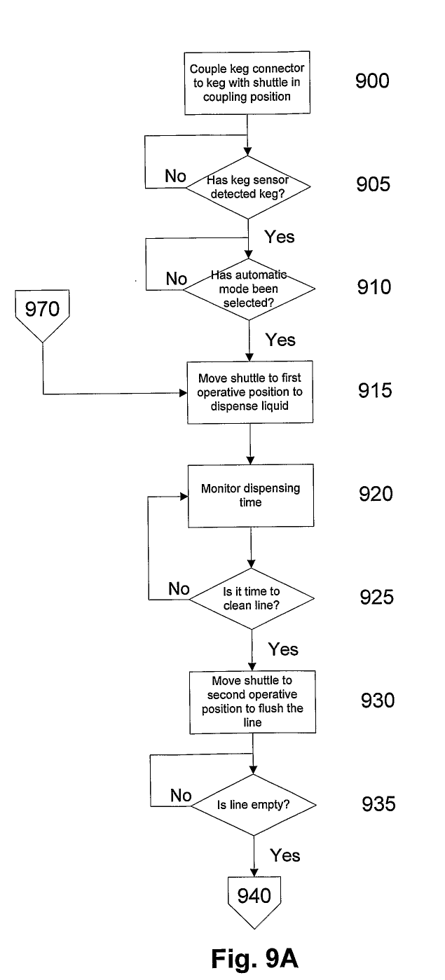

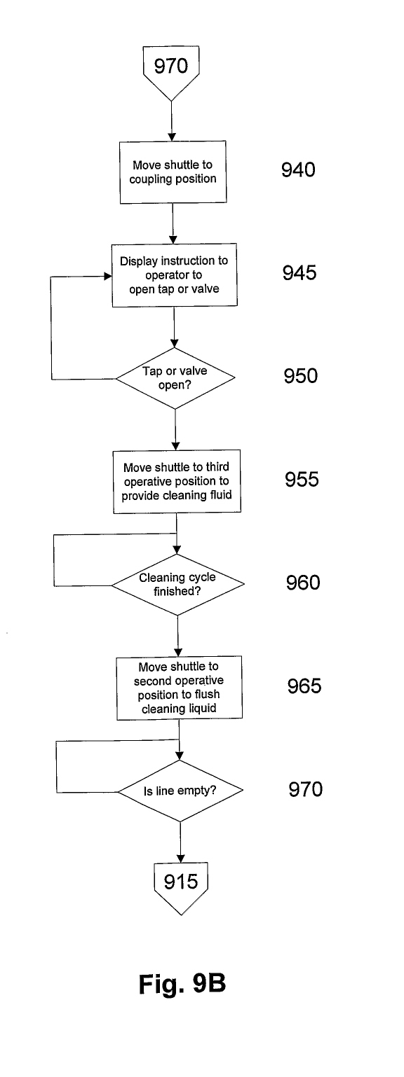

A more detailed example of the process performed by the processing system 3 to clean a beer line will now be described with reference to FIGS. 9A and 9B.

At step 900, the keg connector 14 is coupled to the keg 12 with the shuttle 120 initially positioned in the coupling position to prevent gas, cleaning solution and liquid from flowing into the keg connector 14.

At step 905, the processing system 3 determines, using the keg sensor 140, whether a keg 12 has been coupled to the keg connector 14. If the keg sensor 140 has not detected the presence of a keg 12, this process is repeated until the keg sensor 140 has detected a keg 12, at which point the processing system 3 moves to step 910.

At step 910, the processing system 3 waits until automatic manual mode is selected, which may be selected either using the processing system 30, or a separate switch. Once the automatic mode is selected, the processing system 3 continues on to step 915, otherwise, the keg connector 14 can be operated manually.

At step 915, the shuttle 120 is moved to the first operative position for dispensing beer from the keg 12. In this case, protrusions 145 on the shuttle 120 cooperate with the keg inlet 150 to urge the keg inlet 150 into an open position. Gas from the gas supply 11 is supplied via the gas pressure line 13 the flow path 115, the gas outlet 160, pressurising the keg 12, and causing the liquid in the keg 12 to flow via the second flow path 110, into the beer line 17, as shown by arrow 125.

At step 920, the processing system 3 monitors the dispensing of the liquid. In this case, a number of parameters are measured in order to determine whether the beer line 17 requires cleaning.

This can be based on a number of factors, such as the amount of time or volume of drink that has been dispensed since the last cleaning. In this case, the processor 70 compares a time or measured volume to predetermined thresholds stored in the memory 71.

Alternatively, the processing system 3 can be coupled to suitable sensors to measure the degree of contamination in the beer line 17. This can include, for example, an oxalate sensor 26 and a bacteria sensor 27 positioned in the beer line 17.

The processor 70 obtains signals from the sensors 26, 27 and uses these to assess the operation of the system. The oxalate sensor 26 is typically formed from an ion inline probe that detects the build-up of calcium oxalate inside the beer line, whilst the bacteria sensor 27 detects the build-up of bacteria.

The coolant temperature sensor 28 measures the temperature of the coolant after it has passed through the chiller plate on the return part of the coolant line 9, and may be formed from a thermistor or any other suitable temperature sensor.

The processor 70 monitors signals from the oxalate and bacteria sensors, 26, 27, and compares these signals to predetermined threshold values to determine if there is a build up of oxalate ions or bacteria in the beer line 17.

These thresholds may be set by the drink supplier and encoded in the memory 71, to thereby prevent the thresholds being altered by the operator of the system. This allows the drink supplier, such as the brewery or the like, to ensure that the product is served under optimum conditions, to maintain product quality standards. Alternatively, the thresholds may be set by the user of the system, for example using the I/O device 72.

In any event, if signals from the oxalate and bacteria sensors 26, 27, rise above the predetermined thresholds, this indicates that levels in the beer line are undesirable and that the beer lines needs cleaning.

Accordingly, at step 925, the measured parameters recorded in step 920 are used by the processing system 3 to determine whether a particular threshold has been met to indicate that the line needs to be cleaned. If the measured parameters indicate that the line does not require cleaning, the processing system 3 continues to monitor the dispensing of the liquid. Once a particular threshold has been met, the processing system 3 moves to step 930.

At step 930, the shuttle 120 is moved to the second operative position, with the first flow path 105 aligned with the gas pressure line 13. At step 935, gas is supplied from the gas supply to the gas pressure line 13, allowing gas to flow into the second flow path 110, and then dispense the remaining liquid in the beer line 17. The processing system 3 may selectively control the gas pressure provided by the gas supply 11, using the pressure sensor 25 and the gas control valve 37, such as a solenoid or the like, in order to dispense the remaining liquid.

During this process, the processing system 3 can display a remaining amount of time or volume of liquid to be dispensed before the line is empty. The processing system 3 displays this information to an operator using an indicator, such as the I/O device 72, in order to indicate an imminent cleaning cycle.

At step 940, once the line is determined to be empty, the shuttle 120 is moved to the coupling position to prevent any gas, cleaning solution or liquid flowing through the keg connector 14.

At step 945, the processing system 3 displays, using the I/O device 72, or another external indicator, instructions indicating that a tap 16 or control valve 31 is to be opened in order to dispose of the cleaning solution.

At step 950, the processing system 3 determines whether the tap 16 or control valve 31 has been opened by the operator. This may be determined using a sensor (not shown), or an input device 32 or the processing system 3 used by the operator. If the operator has not opened the tap 16 or control valve 31, the processing system 3 continues to display the instructions. Once the tap 16 or control valve 31 is determined to be open, the processing system 3 moves to step 955.

At step 955, the shuttle 120 is moved to the third operative position. In this case, the first flow path 105 is aligned with the cleaning solution line 24, allowing cleaning solution to be supplied to clean the beer line 17. The processing system 3 may control the supply of the cleaning solution using the a valve to selectively control when and how much cleaning solution is provided to the keg connector 14.

At step 960, the processing system 3 determines whether the cleaning cycle has finished. A number of parameters may be used to determine whether the cleaning cycle has finished, such as the time for which the cleaning has been performed, the volume of cleaning solution dispensed, or the current line state. If the processing system 3 determines that the cleaning cycle has not been completed, the processing system 3 continues to supply cleaning solution. Once the processing system 3 determines that the cleaning cycle has been completed, the processing system 3 moves step 965.

At step 965, the shuttle 120 is moved to the second operative position, to align the first flow path 105 with the gas pressure line 13, thereby allowing gas to be supplied to empty the remaining cleaning liquid from the line at step 985. Data generated by the pressure sensor 25 may by used by the processing system 3 to determine whether the required gas pressure is being supplied to the gas pressure line 13.

At step 970, the processing system 3 determines whether the line is empty using the data generated by the photosensor. If the processing system 3 determines that the line is not empty, the gas is continued to be supplied to the gas pressure line 13 to empty the remaining cleaning solution from the line. Once the processing system 3 determines that the line is empty, the processing system 3 moves the shuffle 120 to the first operative position, such that liquid may again be dispensed from the keg 12 at step 915.

It will be appreciated that a number of variations of the keg connector 14, system, and method are possible.

The processing system 3 may use a number of parameters in order to determine whether the line requires cleaning. This may include, for example, the quantity of beer dispensed, the different brands of beer dispensed, such as draught, lager, ale and stout, which all require different cleaning intervals. However, other parameters, such as the age of the line, would also be appreciated by people skilled in the art.

The processing system 3 may be configured to perform error detection using the data transferred from the various sensors in the system. For example, if the flow meter 30 generates data indicative of a substantial volume of liquid is flowing in the line when the shuttle 120 is in the coupling position, then the processing system 3 may detect an error. The processing system 3 may further provide, via the output device 330, an indication of the error and which part of the system may have caused the error. This may be achieved using a lookup table which includes correct operating ranges for the generated data obtained from the sensors in the system.

The processing system 3 can also determine how frequently the beer lines are being cleaned, by monitoring for a decrease in the levels of oxalate and bacteria within the beer lines. By recording such decreases, this allows the processing system 3 to determine how long it is since the beer lines were last cleaned. Again, this can be compared to a predetermined threshold stored in the memory 71 indicating how often the beer lines should be cleaned. In the event that this threshold is exceeded, the processing system 3 can again generate an alarm to alert the operator to this fact using the I/O device 72, or may alternatively displayed on a separate display, as shown for example at 34.

The processing system 3 can sample signals obtained from the gas pressure sensor 25, to determine an indication of the current pressure in the pressure line 13. The processor 70 will then compare this value to a predetermined gas pressure range stored in the memory 71, which defines an acceptable range of gas pressures representing normal operating conditions. The processor will determine if the gas pressure is within this acceptable range, and if not generates an alert to inform the user that there is a problem with the gas supply. The alert may be generated on the I/O device 72, or may alternatively displayed on a separate display, as shown for example at 34.

Similarly, the processing system 3 can determined problems with any part of the cooling system by detecting increases in temperature solely within the coolant lines 19, for example, by using a temperature sensor 28. There are usually be temperature variations in the coolant temperature depending on factors such as the volume of beer being dispensed. In particular, if a high volume of beer is dispensed, this increases load on the coolant system and may lead to an increase in coolant temperatures within acceptable limits. This can be accounted for by monitoring the temperature at periodic time intervals and comparing rates and/or magnitudes of temperature change to predetermined thresholds, it is generally possible to determine if the coolant system is not functioning sufficiently well to cool the beer.

However, any such temperature increase may be due to a fault with the chiller plate, the coolant line 19, or the coolant supply 18, itself. Accordingly, providing a separate operation sensor 29 that monitors if the coolant supply 18 is functioning correctly, this allows the source of the problem to be located. For example, if the coolant supply 18 is functioning correctly, but the coolant temperature has increased, this suggests a problem may have occurred with the chiller plate or the coolant line 19.

In addition to this, the presence of the operation sensor 29 can allow any problems with the coolant system to be detected before there is an increase in the temperature of the coolant lines 19, and hence the beer lines 17. It will be appreciated that this will help prevent stock wastage through the dispensation of warm drinks.

The processing system 3 can also be adapted to store signal data representing the values of the signals sampled from the sensors 25, 26, 27. 28, 29, in the memory 71, or a remote database shown in dotted lines at 6. This allows the values to be reviewed at a later date, allowing the operation of the machine to be checked. This check may be performed by the operator, and/or by an independent third party for the purpose of ensuring product standards. Thus, for example, the drink supplier may require that the signal data is periodically reviewed by a representative, to thereby ensure that the beer lines are being cleaned as required, as well as to ensure that the beer is being served at correct conditions.

In the event that a fault occurs, such as the levels of oxalate or bacteria in the beer lines exceeds the predetermined thresholds stored in the memory 71, the processing system 3 can also be adapted to prevent further drinks being dispensed until the problem is rectified. A similar course of action can be taken with regard to the cleaning of the beer lines. The processing system 3 may also generate an alert in order to ensure that the operator is aware of the problem.

Additionally multiple levels of thresholds can be set, for example, with a first level to indicate cleaning is soon to be performed, and with further levels indicating that cleaning must be performed before further drinks are dispensed.

The tap 16 or line control valve 31 may be placed in an open position such as to allow for manual or automatic dispensing. For example, if the tap 16 is placed in an open position, liquid will be dispensed by the processing system 3 operatively selecting the position of the valve 31, thereby allowing automatic dispensing of liquid from the keg 12. In this case, the processing system 3 may determine if a required volume of liquid has been dispensed using data generated by the flow meter 30 in order to switch the flow control valve 31 between an open and closed position.

In an alternate example, the control valve 31 may be placed in an open position, thereby allowing an operator to manually control the tap 16 so as to dispense the required volume of liquid.

The processing system 3 may be configured so as to perform the cleaning process according to a timetable stored by the processing system 3. The timetable may be dependent on a number of variables including time periods when low dispensing rates occur, so as to cause minimum disruption.

It will be appreciated that the system may be controlled by an operator's panel rather than automatic control by the processing system 3. The operator's panel allows for manual operation of the system by an operator.

It will further be appreciated that the beer or similar beverages are typically dispensed by the system. However, other liquids may also be dispensed which are provided in a pressurised keg apparatus.

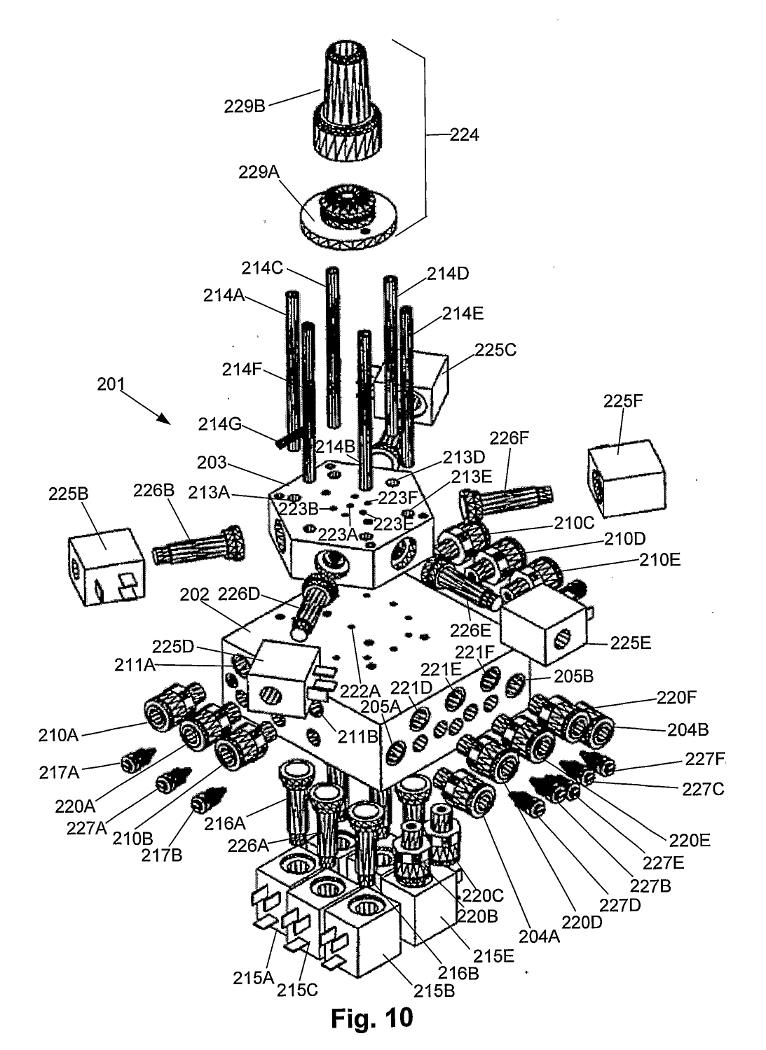

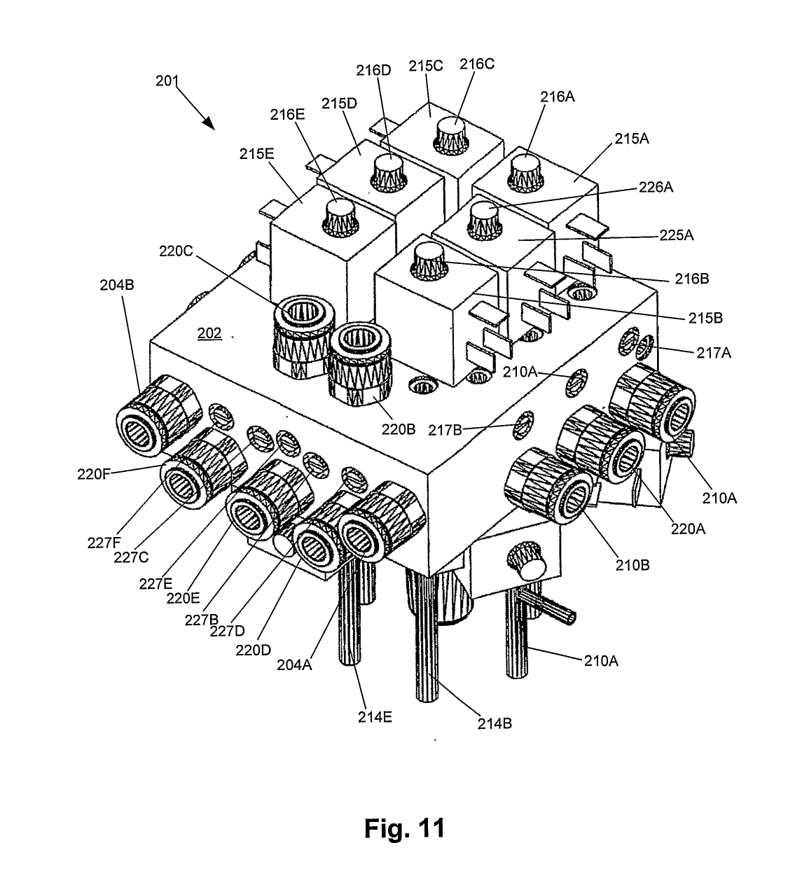

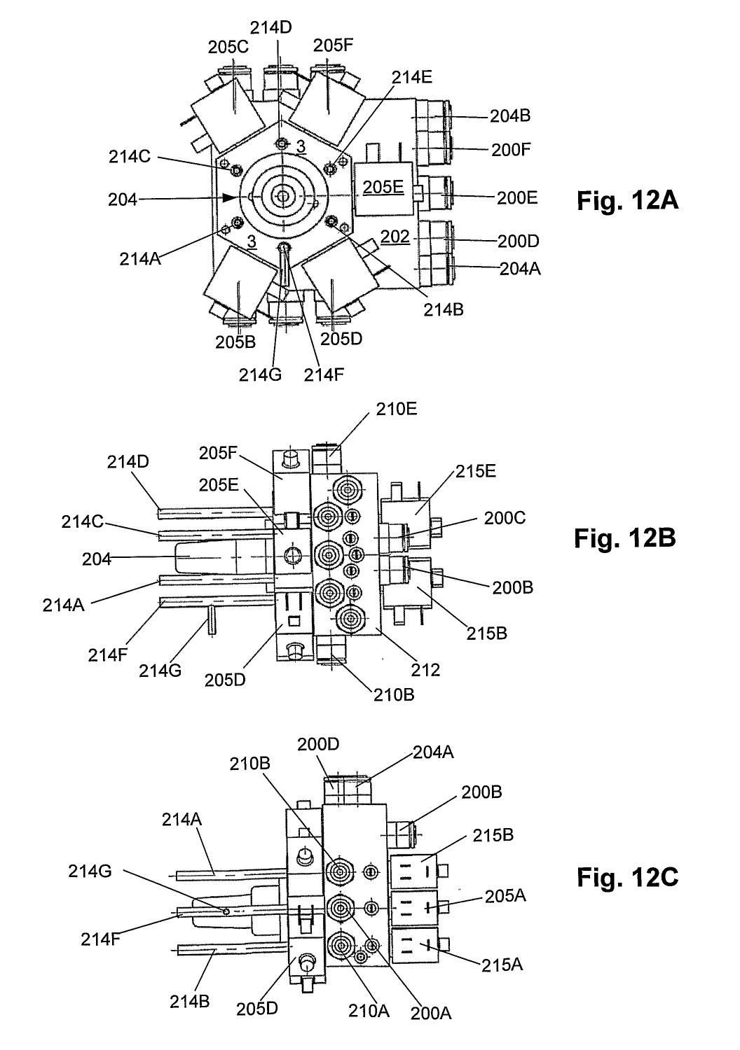

An example of a multivalve that can be used for supplying mixtures of liquids will now be described with reference to FIGS. 10 to 15. This example will focus on the use of the valve 201 to allow a number of drink components to be mixed so as to provide a number of different varieties of drink. The valve system may be used to dispense any forms of drink formed from different components. For the purposes of clarity only the following example will be described with reference to use of a combination of up to five different spirits, and up to six different soft drinks formed from a combination of soda and up to five syrups. However, it will be appreciated that this is for the purpose of example only and is not intended to be restrictive.

In any event, in this example the valve 201 is formed from an inlet housing 202 coupled to an outlet housing 203 as shown. The inlet housing 202 provides a number of inlets for receiving the respective drink components and then couples these via respective flow-paths to corresponding outlets.

In this example, the inlet housing 202 includes five spirit inlet connectors 210A-210E mounted in respective spirit inlet ports 211A-211E (211C-211E not shown for clarity) to allow the inlet ports 211A-211E to be coupled to respective spirit sources via appropriate connection pipes, or the like. The spirit inlet ports 211A-211E are connected via respective spirit flow-paths 212A-212E, formed by apertures extending through the inlet and outlet housings 202, 203 to respective outlet ports 213A-213E (213B-213C not shown for clarity), which are in turn coupled to corresponding spirit outlets 214A-214E.

In use, flow of spirit along the flow-paths 212A-212E is controlled through the use of valves formed from solenoids 215A-215E and corresponding pistons 216A-216E that operate to block the respective flow-path 212A-212E by communicating with respective valve seats 218A-218E. Additional flow control is also provided via a respective flow control screws 217A-217E (217C-217E not shown for clarity) that partially block the respective flow-paths 212A-212E.

Similarly, a corresponding arrangement is used for providing soft drinks as shown. Thus, the inlet housing 202 includes six soft-drink inlet connectors 220A-220F mounted in respective soft-drink inlet ports 221A-221F (221A-221C not shown for clarity) to allow the inlet ports 221A-221F to be coupled to respective soft-drink sources via appropriate connection pipes, or the like. The soft-drink inlet ports 221A-221F are connected via respective soft-drink flow-paths 222A-222F, formed by apertures extending through the inlet and outlet housings 202, 203 to respective outlet ports 223A-223F (223C-223D not shown for clarity), which are in turn coupled to a corresponding soft-drink outlet 224.

In use, flow of soft-drink along the flow-paths 222A-222F is controlled through the use of valves formed from solenoids 225A-225F and corresponding pistons 226A-226F that operate to block the respective flow-path 222A-222F by communicating with respective valve seats 228A-228F. Additional flow control is also provided via a respective flow control screws 227A-227F that partially block the respective flow-paths 222A-222F.

In addition to this, an additional cooling system is provided which utilises a cooling inlet connector 204B, and a cooling outlet connector 204A which are provided in respective ports 205A and 205B as shown. In use the cooling ports 205A and 205B are interconnected via a cooling flow-path 206 (not shown for clarity) to allow chilled fluid to be recirculated through the inlet housing 202. This is typically achieved by connecting the cooling inlet connector 204B to a source of chilled soda water as this is readily available and cheap to use, although it will be appreciated that other chilled fluids may be used.

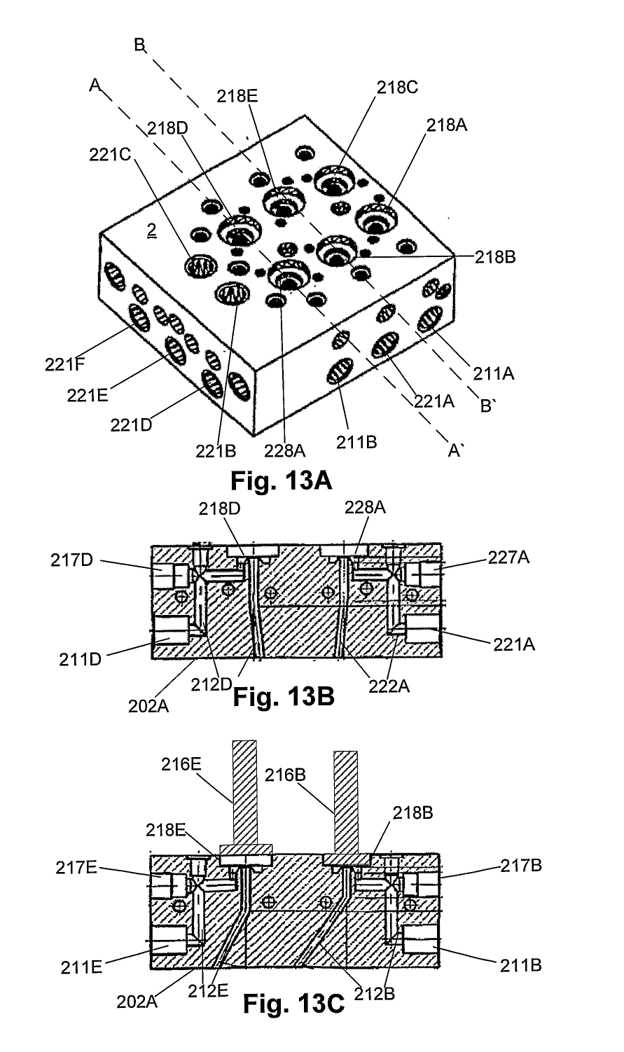

The internal arrangements of the flow-paths 212A-212E, 222A-222F within the inlet housing 202 are shown in more detail in FIGS. 13A to 13C.

In particular, the cross-sectional views through the inlet ports 211B, 211E and 221A, 211D, shown in FIGS. 13B, 13C show that the corresponding flow control screws 217B, 217E and 227A, 217D partially extend into the respective flow-paths 212B, 212E and 222A, 212D thereby partially blocking the flow-path. It will be appreciated from this that the positions of the respective flow control screws 217B, 217E and 227A, 127D controls the relative diameter of the corresponding flow path 212B, 212E and 222A, 212D, thereby restricting the rate at which the respective drink component is dispensed. Similar flow control arrangements are associated with the remaining flow paths, as will be appreciated by persons skilled in the art.

After passing the flow control screws 217B, 217E and 227A, 217D the flow paths 212B, 212E and 222A, 212D extend to a respective piston seat 218B, 218E and 228A, 218D which cooperates with the corresponding piston 216B, 216E and 226A, 216D to allow the flow to be selectively activated.

In particular, as shown by the piston 216B, in FIG. 13C, when the piston 216B is in an extended position, the piston 216B seals against the corresponding valve seat 18B, thereby blocking the flow-path 212B and the corresponding fluid flow. The piston is typically retained in the extended position by having the piston 216B urged outwardly from the solenoid 215B under the action of a respective spring. As a result, in the default position, the flow path is blocked so fluid is not dispensed. In the event that the respective solenoid 215 is activated, the piston 216 is retracted, as shown by the position of the piston 216E, thereby opening the flow-path 212E, and allowing flow of the respective drink component.

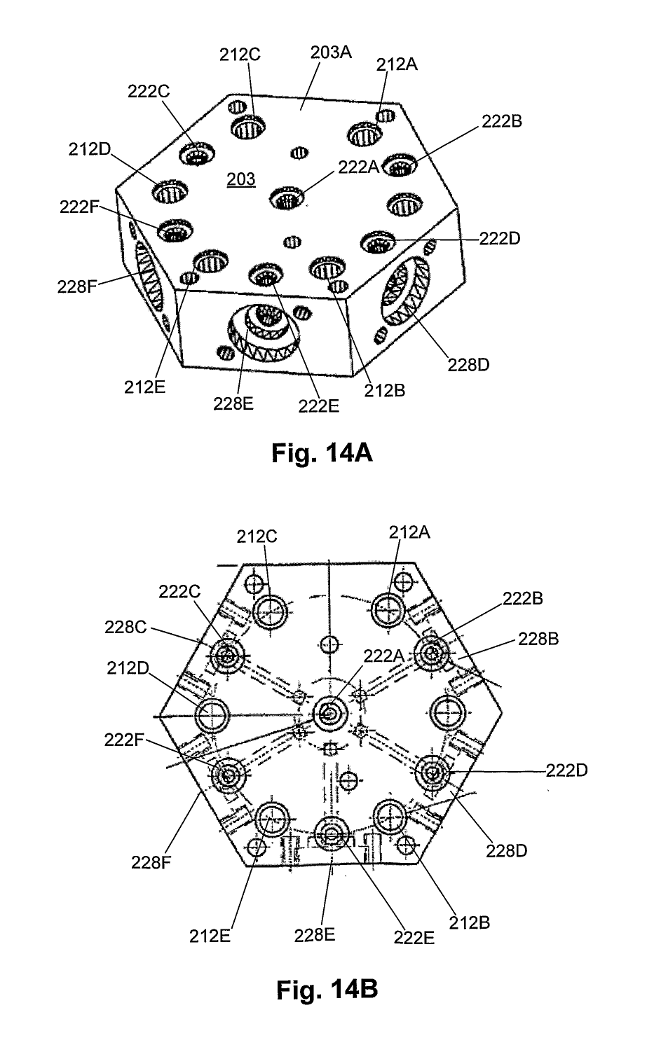

It can be seen therefore that the flow-paths 212, 222 extend through the inlet housing 202 to a surface 202A. In use, the surface 202A is in sealing engagement with a surface 203A of the outlet housing20 3, so that the flow-paths 212, 222 extend through the outlet housing 203, which is shown in more detail in FIGS. 14A and 14B.

In this example, the flow control for the flow-paths 222B-222F is provided in the outlet housing 203. This is again achieved in a similar manner such that the flow-paths 222B-222F flow to a corresponding valve seat 228B-228F in the outlet housing 3, which then cooperates with the pistons 226B-226F in a similar manner to that described above to thereby provide flow control for the soft-drink syrup components. This will not therefore be described in any further detail.

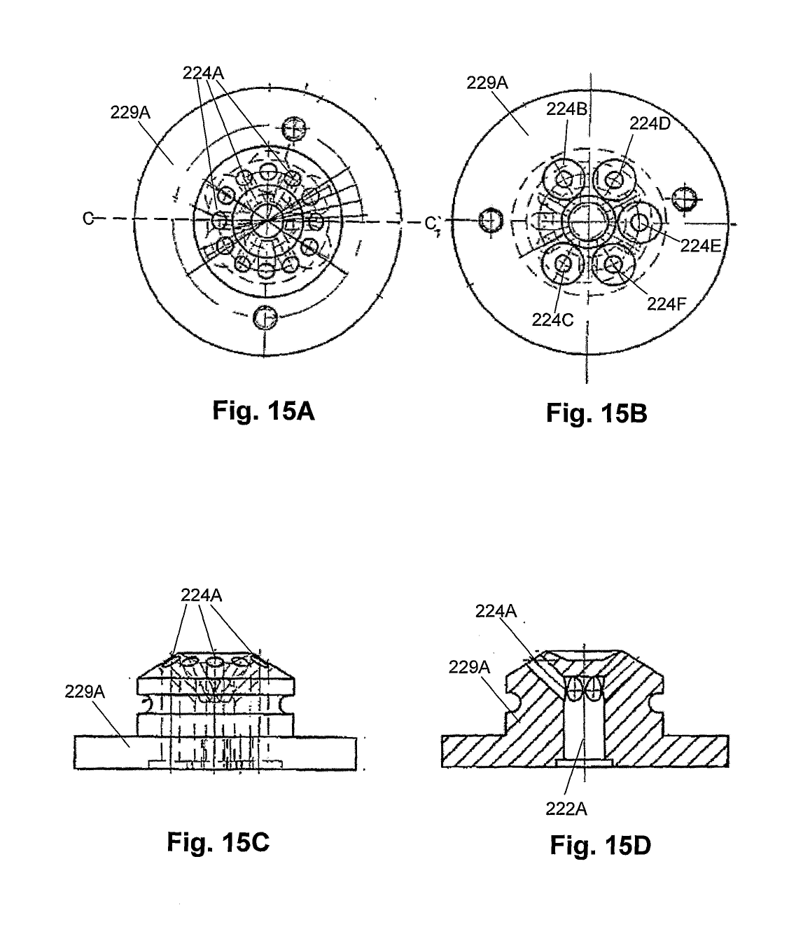

The soft-drink outlet 224 is shown in more detail in FIGS. 15A to 15D. As shown in this example, the flow-path 222A, which provides for soda water to be dispensed extends through a central body portion 229A of the outlet 224 to a number of outlets 224A. Similarly the flow-paths 222B-222F extend through respective outlets 224B-224F around the perimeter of the central body portion 229A.

As a result of this, in use soda flows through each of the outlets 224A and is then directed towards a receptacle via an outer body portion 229B. Similarly, syrup flowing through one of the outlets 224B-224F will also flow within the confines of the outer body portion 229B. As a result of dispersing the soda via the plurality of outlets 224A, this ensures that soda mixes with syrup within the outer body portion 229B, provide adequate mixing of syrup and the soda to form the soft drinks.

Accordingly, it will be appreciated by a person skilled in the art that this provides a common valve housing which may be used to provide a combination of spirits and soft-drinks by appropriate activation of the solenoids 216.

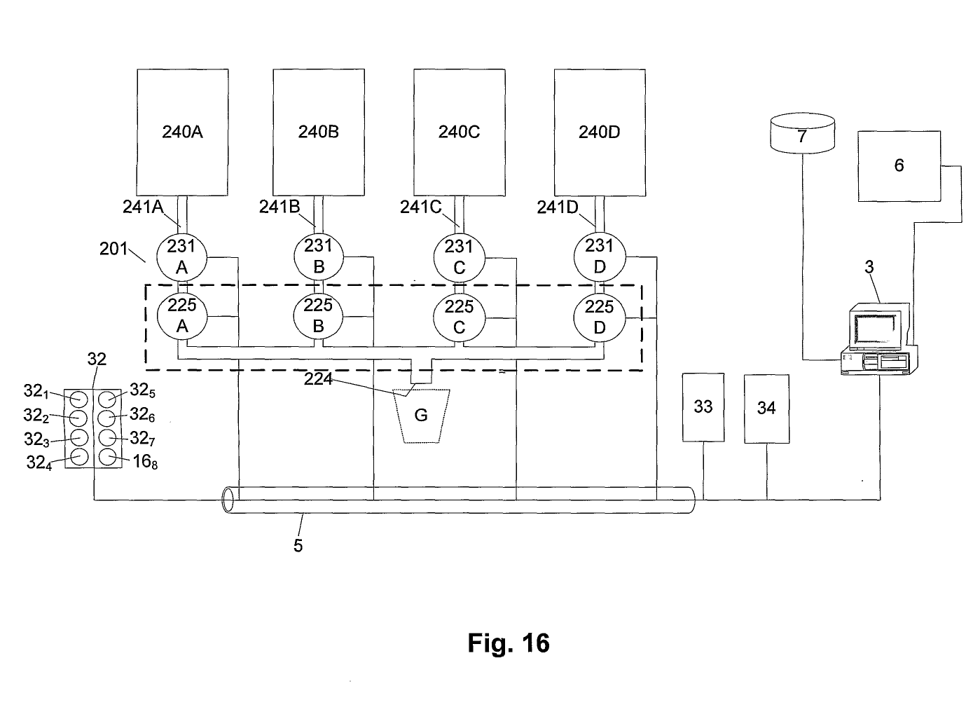

In use, the valve 201 can be implemented in a suitable system for allowing different combinations of drinks components to be dispensed. An example of this is shown in FIG. 16.

This example will focus on the dispensing of four drink components for clarity purposes only, but it will be appreciated that this can be extended to a larger number of components, as described above.

As shown in FIG. 16, the system includes four reservoirs 240A, 240B, 240C, 240D for containing a respective drink to be dispensed. Each reservoir 240 is coupled via a respective flow path 241A, 241B, 241C, 241D to the multivalve 201, which is adapted to supply a drink to a glass or other receptacle as shown at G, via the outlet 224.

A turbine 231A, 231B, 231C, 231D is provided in each flow path to measure the volume of the dispensed drink. The turbines 231A, 231B, 231C, 231D and the solenoids 225A, 225B, 225C, 225D, which form part of the multivalve 201, are typically coupled to a processing system, such as the processing system 3, described above with respect to FIG. 1, thereby allowing the dispensing operation to be controlled. It will therefore be appreciated that this can be implemented in conjunction with the apparatus of FIG. 1, although this is not essential.

The system typically includes an input 32, which in this example, includes a number of input buttons 32₁, 32₂, 32₃, 32₄, 32₅, 32₆, 32₇, 32₈ for selecting drinks as will be described in more detail below.

In use, the processing system 3 operates to receive drink selection via the input buttons 32 and then operate the solenoids 225 to control the dispensing of drinks from the reservoirs 240A, 240B, 240C, 240D. This is achieved in accordance with signals from the turbines 231 as will be described in more detail below.

In this example the system is adapted to dispense drinks such as soft drinks, which are formed from two drink components. In particular, soft drinks are normally formed from a syrup, which provides the flavouring and colour, which is mixed with soda water to provide the desired consistency. For the purposes of this example, the reservoir 240A supplies soda water, with syrups for different drinks being contained in the reservoirs 240B, 240C, 240D.

It will be appreciated by persons skilled in the art that the soda water will typically be formed using water, which is then carbonated in a suitable chamber before being supplied to the flow path 241A. This will not therefore be described in any detail.

In order to dispense a drink, the user, such as a barman or the like will place an appropriate sized receptacle G under the outlet 224. The barman can then select an appropriate one of the input buttons 32₁, 32₂, 32₃, 32₄, 32₅, 32₆, 32₇, 32₈ to cause the drink to be dispensed. It will be appreciated that a number of buttons are provided so as to control the size and/or type of drink that is to be dispensed. Thus, for example, each one of the input buttons 32₁, 32₂, 32₃, 32₄, 32₅, 32₆, 32₇, 32₈ may correspond to a different size of a respective type of drink, such as a schooner, a midi, a pint, or a half-pint of a respective drink.

In any event, the processing system 3 will detect the buttons selected by the user and use this information to access a look-up table (LUT) stored in the memory 21. The LUT will indicate for specific buttons, or button sequences, the type of the drink that is to be dispensed, and in particular will indicate the volume of each drink component that is to be supplied from the respective reservoirs 240A, 240B, 240C, 240D.

The processing system 3 then generates a signal to activate corresponding ones of the solenoids 215, 225. The processing system 3 receives pulses from the turbines 231 representing the volume of drink component dispensed, and uses this to ensure the correct ratio of drink components are provided.

Thus, for any given drink, the volume of each drink component required is determined, and then stored with reference to the number of pulses required to supply the desired drink component volume. In use, the processing system 3 counts the number of pulses from the turbines 231 and once the required number of pulses have been achieved for the selected drink, the processing system 3 will deactivate the respective solenoid 215.

Accordingly, it will be appreciated by a person skilled in the art that different drink components can be provided by utilising a corresponding number of pulses for each drink component as required.

In one example, each pulse from each turbine 231A, corresponds to 10 ml of soda water flow, whereas each pulse from the turbines 231B, 231C, 2312D, represents 1 ml of syrup flow. Thus, in this example, the processing system 3 will operate to count a predetermined number of pulses from each turbine 231 to achieve a desired ratio between soda water and syrup. For example, the processing system 3 may count eight pulses from the turbine 231A, and ten pulses from the turbine 231B, thereby dispensing 80 ml of soda water and 10 ml of syrup, in an 8:1 ratio. It will therefore be appreciated that this allows the drink volumes and hence the ratio of soda water to syrup to be defined in terms of the number of pulses that must be counted for the respective flow meter.

A similar procedure is used for the spirits, thereby ensuring that the drinks are dispensed in accordance with correct ratios. This allows complex drinks, such as cocktails, which include a combination of spirit and soft drink components to be dispensed at the touch of an appropriate input button 32.

It will therefore be appreciated that this system measures the volume of drink dispensed absolutely, and does not operate to dispense an amount of drink based on a dispensing time and flow rate. As a result, even if there is a problem dispensing one of the drink components, such as if one of the flow paths 212, 222 is partially blocked, the required drink will still be prepared as the processing system 3 will simply retain the corresponding valve open until the required volume has been dispensed.

In particular, if the flow of the soda water has been restricted the syrup will cease dispensing first and the soda water will flow until the correct ratio has been reached.

In this case, it will be appreciated that the flow control screws allow alteration of the rate at which a drink component is dispensed, but will not effect the volume dispensed and hence will not effect the ratio of drink components in the resulting drink, which is dependent on the absolute volume dispensed.

In addition to dispensing the drinks as described above, additional drink components can be supplied via the outlet 214F. In particular, the outlet 214F can be connected via an inlet 214G directly to another component source. This is not provided with any mechanism of flow control to thereby allow a variety of drink components to be supplied to taste.

Thus, for example, the inlet 214G may be coupled to a milk source, to allow milk to be added to the drink manually. This has the benefit of allowing manual control of the addition of milk, allowing the drink to be mixed as desired, whilst still allowing the milk to be dispensed into the drink at the same time as other components, and via a single supply valve assembly.

It will be appreciated that the inlet 214G may also be coupled to other sources, such as fresh juices as required.

Additional flow control characteristics can also be provided by suitable using of the processing system 3. For example, the supply of syrup and soda water may be pulsed to help improve the mixing of the syrup and soda water and hence improve the quality of the product. This can be achieved by applying a pulsed signal to the corresponding solenoids 225, to thereby rapidly open and close the corresponding valve. However, in this case, the volume of drink dispensed can again be determined in the same way.

It can be desirable for the drink components to be supplied to the outlets 214, 224 at predetermined times. Thus generally, it may be preferred to supply spirits first, and subsequently supply soft drinks, with the flow of soda water and syrup being substantially concurrent. It will be appreciated that this can be achieved by suitable programming of the processing system 3.

In the example described above, the use of the two housings 202, 203 and the separation of flow control between the two housings 202, 203 is particularly advantageous as this allows the solenoids 215, 225 to be distributed around the valve assembly 201. This in turn provides a spatially optimised arrangement which allows the valve assembly 201 to be incorporated into a dispensing tower or the like, which typically only have a small cavity for receiving the valve assembly. This, in turn, allows the valve assembly to retrofitted into existing drink dispensing systems.

It will be appreciated that whilst the above examples focus on the dispensing of drinks, the technology can be applied to dispensing any form of fluid. Thus, for example, the multivalve can be used in forming any mixture of fluids, such as mixing dyes or paints to produce desired colours.

Content Display System

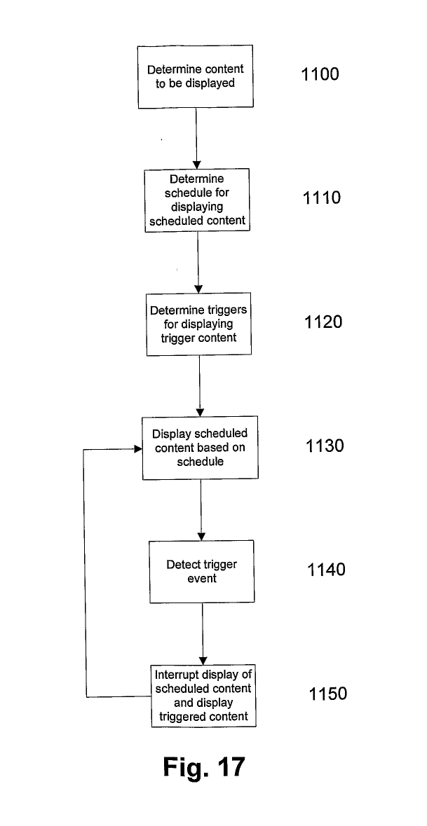

An example of a process for providing context dependent content will now be described with reference to FIG. 17.

In particular, at step 1100 content to be displayed is determined. The content will typically include:
scheduled content, which is generally predetermined non interactive content such as television adverts, or the like; and,
trigger content, which is to be displayed to a consumer in certain context, such as in the event that a certain trigger is detected.

The content may be determined in a number of different manners, depending on the implementation of the system, and may include for example receiving content from content providers, or advertisers, creating the content, or the like.

At step 1110 a schedule is determined for displaying the scheduled content. The schedule is used to control the time at which the scheduled content is presented and may be as simple as a list of the scheduled content that is to be displayed. Thus, for example, this could be in the form of a play list of television adverts, or the like, with each advert on the list being presented in turn following the conclusion of a previous advert. Again, the manner in which the schedule is determined will depend on the circumstances involved, and may involve receiving a predetermined schedule from a content supplier, or generating a schedule using appropriate scheduling algorithms.

At step 1120, triggers associated with the trigger content are determined. The triggers are used to determine a context, and then cause the presentation of suitable content, as will be described in more detail below. Thus, for example, the context could be the ordering of a specific product, with this being detected via the use of a trigger associated with the ordering methodology. In this case, this can be used to trigger the presentation of content relating to the specific product in question.

At step 1130, the process involves presenting scheduled content in accordance with the schedule. This is a standard process that allows content to be displayed in a venue or other location. In this case, whilst the content may be tailored to the environment in which it is presented, it will still tend to be generic content which is not context specific.

During this process, monitoring is performed to detect a trigger event. Examples of trigger events and their detection will depend on the circumstances in which the system is used, and the triggers determined at step 1120, as will be described in more detail below.

In any event, following the detection of a trigger at step 1140, the presentation of the scheduled content is interrupted, thereby allowing the corresponding trigger content to be displayed at step 1150. In this instance, by selecting the trigger content based on the type of trigger, this allows the content to be specifically directed to the context in which the trigger occurs. Once presentation of the trigger content is completed, this allows the process to return to step 1130, to present further scheduled content in accordance with the schedule, and to continue monitoring for further triggers.

Thus, it will be appreciated that this provides a mechanism for providing directed context dependent content and in particular directed advertising, to consumers based on trigger events. In this case, the trigger content is associated with the trigger so that the presented content is relevant to the viewer based on any actions they are performing, thereby making the content relevant to the user, and thereby enhancing the effectiveness of the advertising, or the like.

Thus, for example, the trigger could be having the consumer interact with a product item in a shop. In this instance, when the product item is handled by the user, such as when the item is removed from the shelves in the shop, this could trigger the presentation of advertising associated with the product, thereby encouraging the user to purchase the product. In this instance when the user approaches a shelf in a shop, a display in the vicinity of the product item is presenting scheduled advertising. As the user removes the product item from the shelving, appropriate sensors in the shelving detect this, and an advert specific to the respective product item is displayed. Additional examples of trigger scenarios will be discussed in further detail below.

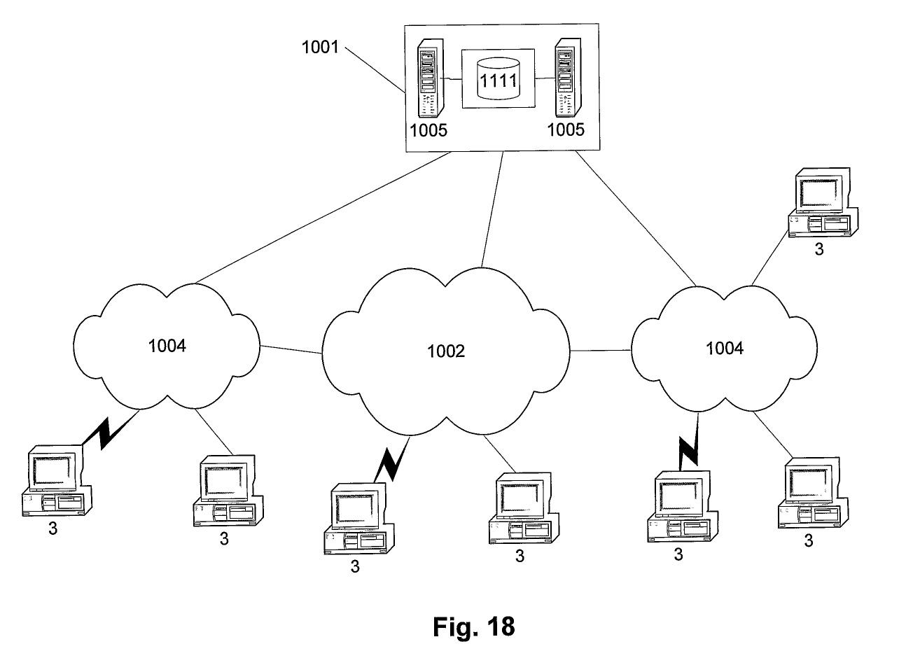

In any event, an example of apparatus suitable for implementing the invention will now be described with reference to FIG. 18.

In particular, FIG. 2 shows a network architecture for allowing content to be provided to one or more local venues. In this instance the system includes a base station 1001 coupled to a number of processing systems, such as the processing system 3 described above with respect to FIGS. 1, 2 and 16, via communications networks 1002, 1004, such as the Internet, or one or Local or Wide Area Networks (LANs or WANs). The networks, and connections thereto may be wired or wireless depending on the preferred implementation.

The base station 1001 typically includes a processing system 1005 coupled to a database 1111 as shown. The processing system 1005 and the processing systems 3 may be any form of suitable processing system, such as a computer system, computer server, desktop computer, lap-top, specialised hardware, or the like.

The one or more processing systems 3 may be provided at a local venue to thereby allow content to be presented. In one example, the processing systems 3 can be provided in drinks dispensing systems similar to those shown in FIGS. 1 and 16, thereby allowing drinks to be dispensed, and corresponding content presented on one of the displays 34.

In the case of the processing system 3, the external interface 73 can be used to connect the processing system 3 to the communications networks 1002, 1004, as well as optionally connecting the processing system 3 to one or more displays 34 and/or one or more sensors.

Accordingly, the processing system 3 may be any suitable computer system, such as a desktop computer, network server, lap-top, specialised hardware, or the like. Alternatively, the processing system 3 may be integrated into a suitable display device, which incorporates processing to allow the presentation of content to be controlled.

In any event, in this example, the base station 1001 is adapted to create, or provide, the content for display at the local venue. The content can be then transferred via the communications networks 1002, 1004, to the processing system 3, allowing the processing system 3 to control the presentation of the content, either in accordance with a schedule, or based on trigger events detected using the sensors.

In addition to this, the base station 1001 will also typically operate to control the creation of schedules and define triggers, as well as to invoice advertisers for the presentation of content.

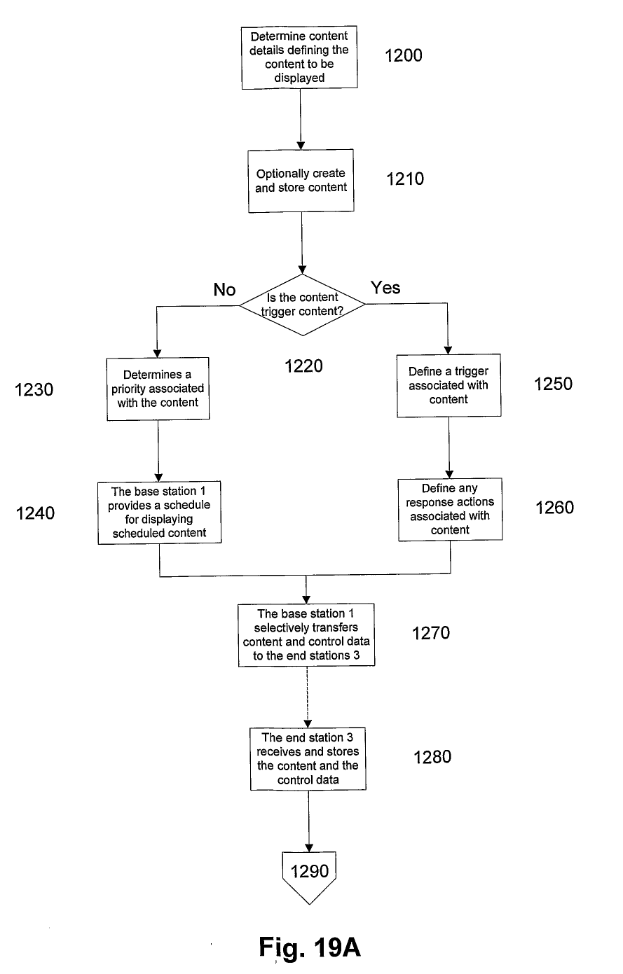

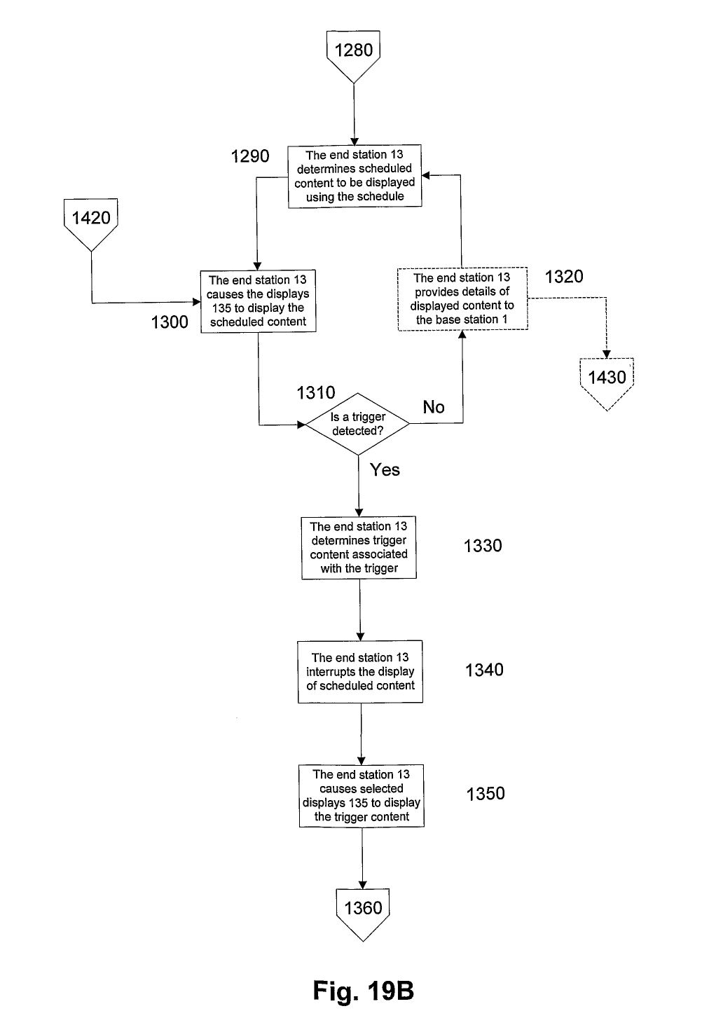

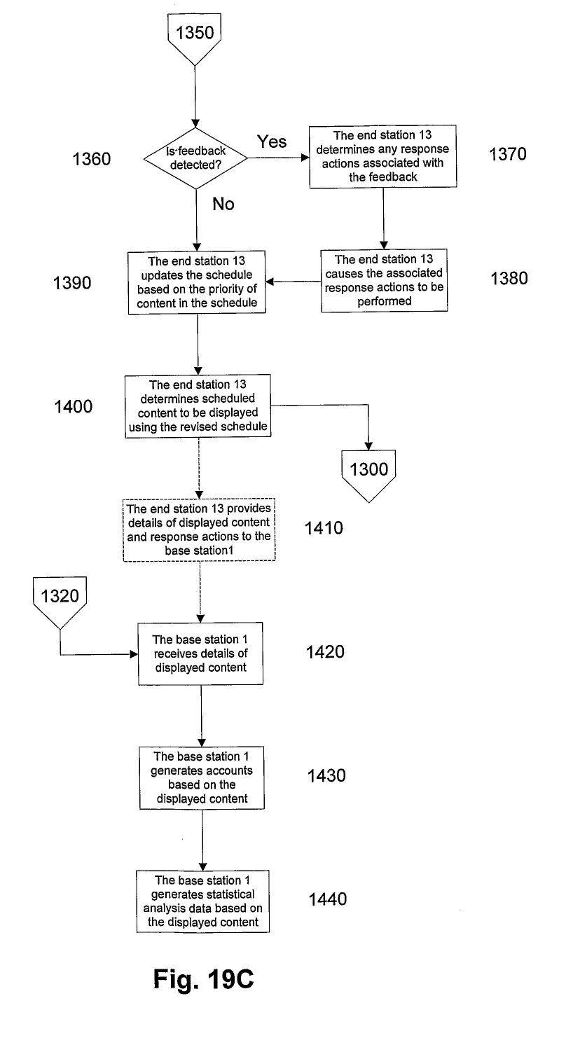

An example of the manner in which this may be achieved will now be described with reference to FIGS. 19A to 19C.

At step 1200 an operator of the base station 1001 determines content details defining the content to be displayed, with the content being optionally created and stored in the database 1111, as required, at step 1210.

These steps may be achieved in a number of manners and will depend on factors such as the nature of the content to be presented, the entity requesting the content presentation, or the like. Thus, for example, advertisers may have pre-generated content which they supply to the base station 1001. Alternatively the operator of the base station 1001 may generate content based on advertiser requirements, which are provided as part of the details of the content to be displayed at step 1200. Additionally the details will include information such as the frequency with which the advertiser wishes the information to be displayed, trigger events that are to be used, and any other required information.

At step 1220 the operator determines if the content is trigger content from the content details. In the event that the content is not trigger content, the operator determines a priority associated with the content at step 1230, and uses this in providing a schedule for controlling the display of the scheduled content at step 1240. The priority may be defined by the operator or obtained from the content details determined at step 1200.

It will be appreciated that schedules may be created on a periodic basis, to control the scheduling of a number of different content items, or that the system may update existing schedules, to allow new scheduled content to be added to existing schedules. Thus, for example, it will be typical for the base station 1001 to create or update schedules periodically, such as each day, week, month or the like, to allow the schedule content to be displayed automatically for a predetermined time period, such as until the schedule is next revised.

The manner in which scheduling is achieved will depend on the particular implementation of the system and will typically utilise known scheduling algorithms. The scheduling is performed in order to ensure that customer requirements specified in the content details are met and will therefore typically result in the creation of a time list indicating when each content item is to be displayed.

Furthermore, as it may be desirable to display different content for different locations, it is typical for a respective schedule to be created for each different location, or for locations of certain types. Thus, for example, different schedules may be created for bars as opposed to shops.

The schedule will also typically include an indication of the priority of the respective content item.

In the event that content is trigger content, then the operator defines a trigger associated with the trigger content at step 1250. The trigger defined is used to control when the trigger content is displayed and suitable examples will be described in more detail below.

At step 1260 the operator also defines any response actions associated with the trigger content. The response actions can vary depending on the nature of the implementation of the system and the requirements of the advertiser. Thus for example, response actions could include providing discounts on selected products as well as causing the presentation of further trigger content. Thus, the response actions may themselves constitute a trigger.

In any event, at step 1270 the base station 1001 selectively transfers content and control data to the processing systems 3. The control data includes any information required to control the presentation of the content, and will therefore typically include schedules and details of trigger events and corresponding response actions, or the like.

It will be appreciated that this may be performed in a variety manners, depending on the implementation. Thus, for example, at the start of each day the base station 1001 may download the content, schedules and other information to each processing system 3 as required. Alternatively however the base station 1001 may download content only when new content is added and simply update schedules or lists of trigger events at the processing systems 3 as required. The transfer of information may also or alternatively be initiated by the processing system 3 using a suitable protocol.

Additionally, the base station 3 may download different content and control data to different processing systems 3, based upon the location of the processing system 3. This ensures that the processing system 3 is able to cause presentation of content that is relevant to the respective venue.

At step 1280 the processing system 3 receives and stores the content and the control data either in memory 71, in a local database, or the like.

At step 1290 the processing system 3 determines scheduled content to be displayed using the schedule, before causing the content to be presented on the displays 34 at step 1300. This is performed in order, depending on the schedule, and will typically involve having the processing system 3 determine the next content item to be displayed, and then download this to the display 34.

Accordingly, the displays can be passive displays that simply display the content provided by the processing system 3. As an alternative however the processing systems 3 may be active in that the content can be downloaded to the display 34 and stored in a local cache, allowing it to be presented at a relevant time indicated by the schedule. In this case, the display is effectively an active display that implements some or all of the functionality of the processing system 3. For the purpose of explanation only, it will be assumed that the displays are passive, but it will be appreciated that the techniques are equally applicable to active displays. Additionally, or alternatively the displays may form part of the processing system 3, such that the processing system 3 and display 34 are integrated.

During this process the processing system 3 continuously monitors for a trigger event, for example by interpreting received signals, such as signals obtained from the buttons 32.

If a trigger is not detected, the processing system 3 will return to step 1290 to cause the next content item in the schedule to be displayed, with this process being repeated until a trigger is detected.

Optionally, the processing system 3 may also provide details of displayed content to the base station 1001, as shown at step 1320. This information can be used by the base station 1001 in billing and determining feedback regarding the effectiveness of the content display, as will be described in more detail below with respect to step 1430. It will be appreciated that the display details may be provided to the base station 1001 each time a content item is displayed, although typically this will be performed on a periodic basis, for example at the end of each day, or on the completion of a respective schedule.

In the event that a trigger is detected at step 1310, then the process moves on to step 1330, with the processing system 3 determining trigger content associated with the respective trigger. The trigger will be detected by having the processing system 3 receive an appropriate input, either via the I/O device 72, as a signal from one or more other processing systems, or from one of the sensors or buttons 32. The nature of the triggers will be described in more detail below.

In any event, the processing system 3 is responsive to the received input to interpret the input and determine the corresponding trigger. The processing system 3 can then use the control data to determine which trigger content should be displayed. The processing system 3 then interrupts the display of schedule content at step 1340, causing the displays to display the trigger content at step 1350.

The manner in which this is achieved will depend on the implementation, but may involve for example, transferring the trigger content to the displays 35, with the displays 35 being responsive to display the trigger content. Thus, if the displays are passive displays and simply present content as it is fed by the processing system 3, this process will effectively interrupt the feed to the displays, and cause feed of the trigger content. Alternatively, if the data is cached in the display 34, the processing system 3 will transfer instructions to the displays 35 causing them to override the presentation of the cached content in favour of alternative cached or feed content.

In any event, the scheduled content is interrupted with the trigger content being displayed instead.

At step 1360 the processing system 3 will determine if feedback is provided or is detected, in response to the presentation of the trigger content. The nature of the feedback will depend on the nature of the content and the manner in which it is displayed. Thus, for example, if the displays are touch sensitive screens, then the feedback could be in the form of a selection made by the user using the screen. Alternatively the feedback may be another form indication such as the purchasing of a product or the like.

At step 1370 the processing system determines any response actions associated with the feedback and then causes these to be performed at step 1380. Thus, for example, this could include providing the user with a discount offered as part of the trigger content. The response actions will de defined by the base station 1001 and transferred to the processing system 3 at step 1270 above as part of the control data.

Thus, it will be appreciated that the feedback may in itself cause further content to be displayed, and therefore constitute a trigger. The main difference between triggers and feedback are however, that feedback is provided in response to presentation of trigger content, and can include a range of response actions greater than simply displaying content.

At step 1390 the processing system 3 updates the schedule to take into account the fact that the presentation of trigger content will use up time that would have otherwise been used to display scheduled content. Accordingly, removal of content from the schedule is required to ensure that the scheduled content fits within the allotted time span for the schedule.

The schedule is generally updated in accordance with the priority of the scheduled content. This allows the schedule to be updated by removing scheduled content that has a low priority, thereby ensuring that high or medium priority content is always displayed. A number of different low priority content items could be available for removal, and the processing system 3 can therefore select an appropriate one of these based on a number of factors, such as:
the relative size of the scheduled content items and the presented trigger content;
the nature of the scheduled content items and the presented trigger content;
the content provider or advertiser of the scheduled content items and the presented trigger content; and,
the order of the scheduled content items in the schedule.

The manner in which this is achieved will be controlled in accordance with a suitable algorithm executed by the processing system 3. It will also be appreciated that priority based alteration of the schedule is not required, and that the schedule may be altered based on any one of a number of factors. However, priority based schedule modification is particularly advantageous as it can help ensure advertisers requirements are met.

At step 1400 the processing system will operate to display scheduled content on the basis of the revised schedule by returning to step 1300. The processing system 3 also may provide details of content displayed and response actions to the base station 1001, at step 1410. This is typically performed on a periodic basis as described above with respect to step 1320.

At step 1420 the base station 1001 receives details of display content and any associated feedback and uses this to allow various information processing to be performed.

This may include for example, generating accounts at step 1430. In this case, as the base station is aware of the number of times each scheduled content item and each trigger content item is displayed, the base station 1001 can charge on a per display basis, taking into account when content items are cancelled from the schedule. Thus, a supplier of content may typically request that the content is displayed ten times a day but in the event that this is not achieved, for example due to the display of a large amount of trigger content, then the content supplier will only be charged for the corresponding number of times the advert that was displayed.

At step 1440 the base station 1001 also operates to perform analysis of the trigger content and any associated feedback. This can be used to determine important information relating to consumer reaction to the presentation of the trigger content, as will be described in more detail below.

Accordingly, the above described process allows scheduled content to be displayed as a default, with the scheduled content being interrupted and hence overridden by the display of trigger content, upon the occurrence of a specific trigger event. This can be used to ensure that the trigger content is relevant to the trigger event, and hence is context dependent. This in turn helps maximise the effectiveness of the content presentation.

In addition to this, the system can operate to determine feedback allowing an analysis of the effectiveness of the advertising to be performed.

Additional features and variations to the above mentioned example will now be described.

Location/Venue/Display Dependency

It is possible for the base station 1001 to generate different schedules to use at different locations and or venues. This could be done based on factors, such as:
the type of venue;
the geographical location of the venue;
preferences of the advertisers; and,
preferences of venue operators.

However, in addition to this, it is also possible to provide a number of different schedules for each venue, with each schedule being used to control the presentation of content on a selected displays. Thus, for example, displays within a venue could be provided as groups, with each group having a respective schedule.

Similar functionality can be provided for trigger content, with different trigger events and different content being defined for different venues, location and/or groups of displays.

Triggers

A trigger is constituted by any detectable action performed by an individual or computer system, and can therefore correspond to a number of activities. This includes, for example, the activation of any switches or other electronic detection systems, as well as purchasing or ordering of products and in the event that unsuitable sensing systems are installed, interaction with product items.

The types of triggers which may be provided includes, but are not limited to, the following:
Product handling;
SMS messages;
MMS messages;
Biometric sensing;
RFID interactions;
GPRS information;
ATM interaction;
Touch screen information;
Motion sensing;
Product purchasing;
GPS information;
Location information; and,
Lift buttons.

In the case of interactive systems such as MMS and SMS, the trigger could be having a user send an SMS to a predetermined number. In this instance, other content, such as a static advert in a venue, or scheduled content, can provide details of the SMS number. When the user sends an SMS, an indication of this is detected by the processing system 3, for example by having the processing system 3 coupled to an appropriate phone, or by receiving a message from the phone network. The processing system 3 can then use this as a trigger to display the corresponding trigger content.

It will be appreciated from this, that when the processing system 3 is determining the trigger content to be displayed at step 1330, it is necessary for the processing system 3 to be able to interpret inputs, either from sensors, the V/O device 72, the buttons 32, or from another processing system, and determine the trigger content from the control data.

In this regard, the control data may define general triggers, such as drink dispensing, and indicate for these triggers the content that should be displayed. In this case, the operator of the processing system 3 can configure their system to interpret inputs, such as signals from one or more of the buttons 32, as corresponding to a specific drink being dispensed, thereby allowing corresponding trigger content to be determined.

Thus for example, an operator of the processing system 3 may use a configuration process to define a mapping between certain received sensors signals, or other inputs, and a list of predetermined trigger events supplied by the base station 1001. In this instance, the mapping can be stored locally, and used to interpret inputs, allowing the processing system 3 to determine the general trigger event that has occurred.

This can then be used to access the control data and determine the trigger content associated with the respective event.

Alternatively, and/or additionally, the control data can provide information for interpreting the inputs received by the processing system 3. Thus, the control data can be used to identify that a particular signal corresponds to a certain trigger, and hence determine the corresponding trigger content.

It will be appreciated that to achieve this requires knowledge of the inputs that will be received by the processing system 3, such as details of the sensor configuration at the location in which the processing system 3 is provided. This can be achieved in a number of ways.

Thus, for example, an operator of the processing system 3 can configure their sensors, buttons, or the like, and then provide details of the sensor configuration to the base station 1001, allowing the base station 1001 to generate appropriate control data for the respective sensor configuration. Thus, the operator can indicate that a selected one of the sensors detects the movement of a particular product item.

This allows the base station 1001 to generate control data that is specific to the respective location. Thus the control data will indicate that upon receipt of a signal from the selected sensor 1036, a certain item of trigger content relating to the particular product item should be displayed.

Alternatively, the base station 1001 can provide instructions to the operator of the processing system 3 regarding how to configure their system, such as which sensors should be used to detect triggers. In this case, different locations can implement standard sensor configurations, thereby allowing common control data to be used in a number of different locations.

It will be appreciated that other suitable techniques for interpreting inputs may also be used, and that typically a number of different approaches may be used in conjunction.

Trigger Content

The type and nature of the trigger content will depend on a number of factors, such as the location of display, the type of product to which it relates and the nature of the trigger. Examples types of content could include:
Adverts;
Discount offers;
Product information;
Infomercials;
Offers;
Data entry screens;
Feedback forms; and,
Vouchers, either printed or couponless.

Response Actions

While any form of response action may be implemented by the system the response action will generally be in the form of interaction with the consumer. The interaction can be with the presented trigger content, such as by providing information in response to a request in the trigger content.

This may be achieved for example by the use of touch sensitive displays that allow the consumer to select appropriate response options provided by the trigger content. This may include for example questions on the product which if the consumer answers it they obtain a discount.

Alternatively, the response actions could be instructions to entities operating the respective venue. This could include cause the entity to apply a discount to a purchased product or the like. In this instance the processing system 3 can therefore also be coupled to one or more systems to allow one or more response actions to be implemented.

The response actions are typically defined as part of the control data. Again, this may be performed in broad terms, with the specific action taken being interpreted by the processing system 3. Thus, for example, the response action may be indicated as providing a discount to the user, with the processing system 3 including details of how the discount is to be provided, for example, through the use of vouchers or the like. Alternatively, or additionally, the control data may specify how the response action is to be performed, and it will be appreciated that this will depend on the specific implementation.

Feedback Analysis

The analysis performed by the base station 1001 will depend on factors such as the nature of the trigger content displayed, the nature of feedback provided and corresponding response actions performed, together with requirements of the advertiser or content supplier.

Thus, in the case of product advertising it is typical for advertisers to want feedback on how well the advertising is working and whether this is resulting in the purchase of items. In this instance the base station 1001 can be used to automatically determine interaction and purchases of products based on the trigger content presented and the performance of any associated response actions.

For example, if content is triggered upon a user reviewing a list of available drinks, for example, in an electronic menu, the base station 1001 can use information regarding how often a respective piece of trigger content is displayed to determine a level of user interest in the corresponding product. In the event that an associated response action is the provision of a discount on purchasing of the item, then by determining the number of discounts applied, the base station 1001 can determine how often consumer interest in the product results in a purchase. This in turn allows the success of advertising to be assessed.

The data is therefore analysed using appropriate statistical analysis, as will be appreciated by persons skilled in the art.

Furthermore, by having each processing system 3 provide details of the location at which the trigger content was displayed, this allows geographical based analysis to be performed, thereby allowing an assessment of how effective advertising is in different locations and different types of venues.

Persons skilled in the art will appreciate that numerous variations and modifications will become apparent. All such variations and modifications which become apparent to persons skilled in the art, should be considered to fall within the spirit and scope that the invention broadly appearing before described.

1-40. (canceled)

41. A method presenting content, the method including, in a processing system:
a) determining content including:
i) schedule content; and,
ii) trigger content;
b) determining control data for controlling the presentation of content, the control data including:
i) a schedule for controlling the presentation of the schedule content; and,
ii) indications of one or more triggers associated with the trigger content; and,
c) causing the scheduled content to be presented on a display in accordance with the schedule;
d) monitoring for one or more triggers; and,
e) in response to the detection of a trigger:
i) interrupting the presentation of schedule content; and,
ii) causing trigger content associated with the respective trigger to be presented on the display.

42. A method according to claim 41, wherein the method includes, in the processing system, and in response to the presentation of trigger content, updating the schedule.

43. A method according to claim 42, wherein the method includes, in the processing system:
a) determining a priority of one or more content items from the schedule; and,
b) removing one or more content items from the schedule in accordance with the determined priority.

44. A method according to claim 43, wherein the method includes, in the processing system, updating the schedule in accordance with at least one of:
a) the relative size of the scheduled content items and the presented trigger content;
b) the nature of the scheduled content items and the presented trigger content;
c) the content provider or advertiser of the scheduled content items and the presented trigger content; and,
d) the order of the scheduled content items in the schedule.

45. A method according to claim 41, wherein the processing system is coupled to one or more sensors, and wherein the method includes determining the one or more triggers in response to one or more signals received from the sensors.

46. A method according to claim 41, wherein the sensors include at least one of:
a) a barcode reader;
b) an electronic input;
c) a processing system input;
d) a system for receiving a communications message; and,
e) a motion sensor for detecting the movement of a product item.

47. A method according to claim 41, wherein the triggers are indicative of at least one of:
a) Product handling;
b) SMS messages;
c) MMS messages;
d) Biometric sensing;
e) RFID interactions;
f) GPRS information;
g) ATM interaction;
h) Touch screen information; and,
i) Lift buttons.

48. A method according to claim 41, wherein the method includes, in the processing system:
a) determining feedback in response to the presentation of trigger content; and,
b) performing one or more response actions associated with the feedback.

49. A method according to claim 45, wherein the method includes, in the processing system, determining the one or more response actions from the control data.

50. A method according to claim 41, wherein the method includes, in the processing system, receiving at least one of the content and the control data from a base station.

51. A method according to claim 41, wherein the method includes, in the processing system:
a) determining indicating data indicative of the displayed content; and,
b) causing the indicating data to be used in determining one or more of:
i) accounting data representing accounts associated with the presentation of content; and,
ii) analysis results indicative of an analysis of the indicating data.

52. A method according to claim 48, wherein the method includes, in the processing system, transferring the indicating data to a base station, the base station being responsive to the indicating data to determine at least one of the accounting data and the analysis results.

53. A method according to claim 41, wherein the displays are at least one of:
a) part of the processing system; and,
b) coupled to the processing system.

54. A method according to claim 41, wherein the method includes, in the processing system:
a) determining the next scheduled content to be displayed; and,
b) transferring the content to the display, thereby causing the display to present the respective content.

55. Apparatus for presenting content, the apparatus including a processing system for:
a) determining content including:
i) schedule content; and,
ii) trigger content;
b) determining control data for controlling the presentation of content, the control data including:
i) a schedule for controlling the presentation of the schedule content; and,
ii) indications of one or more triggers associated with the trigger content; and,
c) causing the scheduled content to be presented on a display in accordance with the schedule;
d) monitoring for one or more triggers; and,
e) in response to the detection of a trigger:
i) interrupting the presentation of schedule content; and,
ii) causing trigger content associated with the respective trigger to be presented on the display.

56. Apparatus according to claim 55, wherein the apparatus includes one or more sensors coupled to the processing system, the processing system being responsive to signals from the sensors to thereby determine one or more triggers.

57. Apparatus according to claim 55, wherein the apparatus includes one or more displays, the displays being at least one of:
a) part of the processing system; and,
b) coupled to the processing system via a communications link.

58. Apparatus according to claim 55, wherein the processing system is coupled to a base station via a communications network, the processing system being for receiving the control data and the content from the base station.

59. Apparatus according to claim 55, wherein the apparatus performs the method of claim 41.

60. A method of causing presentation of content, the method including, in a base station:
a) determining content including:
i) schedule content; and,
ii) trigger content;
b) determining control data for controlling the presentation of content, the control data including:
i) a schedule for controlling the presentation of the schedule content; and,
ii) indications of one or more triggers associated with the trigger content; and,
c) transferring the content and the control data to one or more end stations, each end station being responsive to:
i) cause the scheduled content to be presented on a display in accordance with the schedule;
ii) monitor for one or more triggers; and,
iii) in response to the detection of a trigger:
(1) interrupt the presentation of schedule content; and,
(2) cause trigger content associated with the respective trigger to be presented on the display.

61. A method according to claim 60, wherein the method includes, in the base station:
a) receiving details of the content to be displayed; and,
b) using the received details to generate at least one of
i) the content; and,
ii) the control data.

62. A method according to claim 60, wherein the method includes, in the base station: a) determining one or more response actions associated with the trigger content; and, b) generating the control data in accordance with the response actions.

63. A method according to claim 60, wherein the method includes, in the base station:
a) receiving indicating data from the one or more end stations; and,
b) determining from the indicating data, the displayed content.

64. A method according to claim 63, wherein the method includes, in the base station, using the indicating data to determine at least one of:
i) accounting data representing accounts associated with the presentation of content; and,
ii) analysis results indicative of an analysis of the indicating data.

65-67. (canceled)
